(19) United States
(12) Patent Application Publication
(10) Pub. No.: US 2004/0010434 A1
(43) Pub. Date: Jan. 15, 2004

(54) Information processing method and its supporting system, and tool used for them

(76) Inventor: Hideo Fujita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/343,829

(22) PCT Filed: Aug. 9, 2001
(86) PCT No.: PCT/JP01/06876

(30) Foreign Application Priority Data
Aug. 9, 2000 (JP) 2000-241766
Jun. 11, 2001 (JP) 2001-176220

(51) Int. Cl. G06F 17/60

(52) U.S. Cl. 705/8

(57) ABSTRACT

A method for information processing carried out by an organized group having information processing means independent of one another and each having knowledge, knowledge expression, knowledge evaluation data, a knowledge evaluation function, a concept, and a learning algorithm (hereinafter referred to as knowledge etc). The method comprises a dividing step of dividing the information processing means into groups, a first work step of attaining a result of the information processing achieved by each group, and a second work step of attaining a result of information processing achieved by the whole groups by integrating the results of the information processings carried out by each group. The division performed at the dividing step is made so that the results of the information processings are different from one another. In the first work step, each group conducts a work independently of the others. The second work step includes a first evaluation substep in which each group evaluates the results of the information processings achieved by the other groups by using common evaluation criteria.

### TECHNICAL FIELD

This invention is related to methods of information processing, a support system therefor, and tools used therewith in order to improve productivity in industries by aggregating knowledge and the like of a plurality of people and computer agents by ergonomical methods and artificial intelligence methods.

### BACKGROUND TECHNOLOGY

In production activities of various industries, the improvement of productivity is very important as productivity directly affects the results of production activities and influences the development of the industry. For instance, as an example of improving of productivity, the reduction of manufacturing costs in manufacturing industries, more concretely the realization of the improvement of material utilization efficiency, improvement of the yield rate, improvement of the rate of the operation of machine facilities, and the like are important. Also in another example, with regard to the improvement of product development efficiency, for instance, the improvement of efficiency in understanding the needs of customers, the improvement of appropriate decisions for the corresponding product specifications, the shortening of the development of element techniques, and accurate introduction of production facilities become very important. Moreover, in improving business efficiency, efficient and precise understanding of market conditions, and efficient activity in conceiving new needs based on the conditions and methods of efficiently delivering products to and bill collections from the customers are very important. Also, for instance, the improvement of efficiency in solving problems (for instance, shortening of time) related to the rate of occurrence of substandard products at the manufacturing site, improvement of efficiency in solving problems related to complaints from customers (decreasing the number of complaints or developing new products and services based on complaints) are included in the improvement of productivity.

Productivity in various cases in various industries depends largely on the efficiency of processing of information which promote work. That is, the efficiency of a series of information processing where information related to an object is acquired accurately and quickly processed and creation of a countermeasure from the results, execution of the countermeasure and modification of the countermeasure by new information collected during execution will substantially control the productivity. Therefore, the efficiency of information processing (i.e. intellectual creative work) which promote work will largely govern the results of industrial activity and as a result will greatly influence the development of the industry. Therefore, a highly efficient method of information processing is necessary, and it is earnestly desired especially in recent years when information techniques have been developed.

In industrial information processing, the subject is an organized group of an aggregate of people or a computer agent. In the following, existing problems in each case will be described.

When the subject of performance is an organized group which is an aggregate of people, each person may be positioned as an information processing means. In the conventional method of information processing, there was no efficient arrangement for individuals (each information processing means), which compose the organization, to make other members of the organization (other information processing means) sufficiently understand the knowledge (hereafter information, opinion, knowledge, knowledge expression, knowledge evaluation data, knowledge evaluation function, concept, learning algorithm and the like will be referred to as knowledge) they possess, and information processing was conducted without an efficient arrangement whereby the knowledge of each individual is developed as a group. Thus, the low efficiency of information processing of a group caused low productivity and became a large problem.

For instance, a conference may be considered as a kind of information processing conducted by an organized group but the methodology for conducting the conferences had the following problems. That is, in methods of conventional conferences, the participating members usually relate their opinion under the leadership of the chairperson, but in this case a speech will usually be influenced more or less by a speech made previously by another member and will not express the original thoughts of each individual. Moreover, the speaker will not clearly deny the opinion of the previous speaker and will find a point of compromise and will make an insertion modifying his own opinion and will try hard to avoid conflict with the opinion of other members. Therefore the conclusion of the conference will be a compromise to the first speaker or to a proposal of the person in charge of the organization formation. Naturally, the degree of agreement of the contents of the conference will be very low. As a result, although the attendants of the conference appear to have agreed to the conclusion of the conference, they actually do not sufficiently consent to the conclusion and it is usual that even minimal correspondence cannot be achieved. By such methodology of conventional conferences (that is information processing) the results of action based on the conclusions of the conference will also be low and not only productivity will be very low but the efficiency of such conferences will be low because of lengthy conference times.

In the past, several improvement plans for this problem have been proposed. That is, in the official report of Japanese Patent Laid-Open No. 10-303892, a trial of a method for management of conferences and its support device whereby the conference participants are divided into a plurality of groups (higher rank conference group and lower rank conference group) and managing the conference efficiently by advancing discussions for each theme individually and by decreasing the total amount of information, has been proposed. However the official report does not provide an opportunity for heated discussion of conference results of each group and also does not provide a chance for heated discussions between individual knowledge and the like, and knowledge and the like of other people. Therefore, similar to past conferences mentioned above, the conclusion is an obscure compromise and has problems similar to that mentioned above. Also, there was a problem of inefficient information processing as a result of the reduction of diversity due to lack of opportunity to enjoy diverse viewpoints as a whole.

On the other hand, in “Conference Technique: New Level of Concept Opened by Teamwork” (Written by Shinichiro Yoshida, published by Chuokoron-Shinsha on Feb. 25, 2000), a method for management of conferences is proposed where discussions are advanced by dividing the whole group into a plurality of groups. However, this method is only a technique for people who do not make an oral presentation or speech (a technique to have these people make an oral presentation or speak out). Therefore, the opportunity for each individual to present an opinion or speak out will be increased to some extent by this technique but since there is no contrivance for the knowledge of each individual to compete with the knowledge and the like of the organization members and develop it as a group, discussions in the conference by this technique will only be superficial. Moreover the method to discuss the contents of discussions made by each group by integrating the contents as a whole is not disclosed, higher level results for information processing which can only be attained by mutually competing results of information processing of each divided group cannot be produced and, as a result, the efficiency of the conference (that is, information processing) remained low.

Also, as an example of information processing related to the improvement of productivity outside the scene of a conference, there is information processing methods related to improving efficiency in production of articles, more definitely for example, information processing to realize production methods with lower production costs. As an former example, a method was used whereby, for example, the heads of an organized group will establish a policy to lower production cost and other important problems and based on this, the managers will establish detailed plans and definite methods and lower level members of the organization will simply execute the methods set forth. That is, in information processing related to improvement of productivity up to now, information processing was of the type where plans and definite methods were contrived based on limited knowledge possessed by the heads and the middle managers were only transmitted to the organization members and the lower level members only executed the plan. That is, it was not information processing where knowledge and the like possessed by individuals of the group including lower level members was effectively integrated, but, as it were, just information transmission in a limited direction from top to the lower level members. Therefore the conventional method of information processing to improve productivity was not effective and as a result a significant reduction of manufacture cost could not be realized and productivity was poor.

Also, as another concrete example of information processing to promote productivity, there is information processing related to efficiency in making of business plans. Up to now, the conventional method of information processing in this case was to discuss and revise the business plan proposal prepared by a part of planning supervisors at a conference composed of top-ranking people, and to choose an agreed upon business plan. In this case, as the members of organization who execute the business plan are not members who contrived the business plan, there was difficulty in holding the contents of the business plan in common and the results of the business (achievement) were low. This is due to the fact that in the task of information processing of making business plans, there was no opportunity to develop and integrate the knowledge and the like possessed by individuals of the organized group.

The case where the subject of the information treatment is a computer agent will be described. Up to now, various kinds of information processing using computer agents have been performed in various fields of industry. For example, software for writing compositions or drawing figures, various retrieval software, various data base software for knowledge management, various agents acting on the internet, forecast software for financial market and the like, information management software in companies, support software for factory operation, support software for distribution and the like may be cited. These computer agents which execute information processing may be considered as an information processing means with knowledge.

Formerly, trials to promote efficiency of information processing by preparing a plurality of aforementioned information processing means were made but in this case the basic arrangement was to have a plurality of information means to possess the same knowledge and the like and aimed simply at rapidly obtaining results of information processing. That is, a plurality of information processing means were made to execute information processing cooperatively and not to compete with each other. Therefore they could not process higher degree information processing by developing initial knowledge and the like, and were able only to derive simple results obtained by extending initially set knowledge and the like, and as a result, the quality of information processing results was very poor and it was very difficult to produce results of information processing with intellectual creativity (emergence: for instance, formation of new interpretation and concept for a phenomenon, new conceptions and the like). In order to achieve results of information processing with intellectual creativity by conventional methods, an impossibly large data capacity and high operation speed would be necessary and thus would actually be impossible.

Also, up to now there have been trials of competition learning in neural networks (for instance, Recognition and Learning, Software Science 16, Iwanami Kohza 16, written by Yuichirou Yasunishi, published by Iwanami Shoten on Feb. 6, 1986, p.346) or trials by attaching different knowledge and the like to a plurality of information processing means and processing information by modifying knowledge and the like by genetic algorithm (for instance, In Search of Collaboration, Cognitive Science on Creative Collaboration, coauthored by Kazuhiro Ueda and Takeshi Okada, published on Nov. 15, 2000, p.210) have been proposed, but also in these cases, each information processing means is made to act systematically as a group and an efficient concrete means including integration of the information processing results of each information processing means as a group was not disclosed. Therefore, the efficiency of information processing of these cases was very poor.

As described above, by methods of conducting conferences and its support contrivance proposed above and the method described in “Conference Technique: New Level of Concept opened by Teamwork” or in the past information processing method for improving productivity, as the knowledge and the like of each individual constituting the organized group could not be expected to be utilized effectively, development and unification by the group could not possibly be expected and the efficiency of information processing was very low.

Moreover, as organized groups composed of a plurality of computer agents have only functioned by mutual cooperation and do not have competition functions, it is practically impossible to produce highly efficient information processing.

This invention was made in view of these circumstances. That is, the object is to provide methods of information processing and a support system therefor and provide tools used therewith to obtain high level information processing results by the full use of intellectual creativity of individuals constituting organized groups of a plurality of people efficiently in a short time at a low cost and also to provide highly efficient information processing methods for organized groups consisting of a plurality of computer agents with respective knowledge and the like, and to realize high productivity.

### SUMMARY OF THE INVENTION

The entity-dividing support methods of this invention are,

(a) a step to input IDs and attributes of a plurality of entities into a computer,

(b) a step to input into the computer or calculate by the computer the value of said attribute of each entity and,

(c1) a step to divide a plurality of entities into a plurality of groups by a plurality of modes or methods by use of the computer,

(c2) a step to grant a division ID to each of said modes or methods of the division by use of the computer,

(d) a step in which the computer calculates an average value and a deviation of the attributes of a plurality of entities belonging to each group of the groups belonging to each division ID,

(e) a step in which the computer generates at least one group pair from said groups belonging to each division ID,

(f) a step in which the computer calculates a distance between the group pairs based on the attribute average value and attribute deviation of the group belonging to the group pairs,

(g) after the repetition of the steps (c)-(f) for a plurality of division IDs with which said entities are divided into the same number of groups, for each division IDs which divides into the same number of groups, a step in which the computer determines a group division ID which includes a group pair with the largest distance between group pairs, and

(h) a step to display on a display device the division ID which includes the group pair with the largest distance between group pairs, together with the maximum value.

Another aspect of this invention is an entity-dividing support device.

The entity-dividing support device comprises

a memory which stores IDs and attributes of a plurality of entities and,

a memory which stores values of the attributes of each entity,

a memory which stores division IDs which specify modes and methods of dividing said entities into a plurality of groups,

a means to divide said entities into a plurality of groups by modes or methods specified by the division IDs,

a means to calculate an average value and a deviation of a plurality of entities included in each group of groups which belong to each division ID,

a means to generate at least one group pair from said groups belonging to each division ID,

a means to calculate a distance between said group pair on the basis of the attribute average value and the attribute deviation of groups belong to said group pairs,

a means to determine the division ID which includes the group pair where the distance between the group pair is the maximum for each plurality of division IDs with which said entities are divided into the same number of groups, and

a means to generate a display image which displays the division ID which includes the group pair with the maximal distance between the group pair and the maximum value for each division IDs with which said entities are divided into the same number of groups.

It is preferable for the device to comprise a memory which stores weights of the attributes.

Also it is preferable for the device to comprise a means to determine the group pair which has the largest distance between the group pairs for each attribute in each division ID, when a plurality of attributes are stored for each entity,

a means to calculate the sum of the largest distance between group pairs for each attribute, and

a means to determine the division ID where the sum of the largest distance between group pairs is maximal for each division IDs with which said entities are divided into the same number of groups.

Also, in the case where a plurality of attributes of each entity are stored, the device may have a means to calculate the sum of distance between group pairs for each attribute in each division ID, and

a means to determine the entity division ID where the sum of the distance between group pairs is maximum, for each plurality of division IDs with which the entities are divided into the same numbers of groups.

Also, another aspect of this invention is a method to support intellectual creative work by use of a computer network system which has at least one server and a plurality of clients. This method includes,

a step in which the server divides the clients into a plurality of groups including a plurality of clients,

a step to send information requesting to propose solutions to a problem to all divided clients,

a step in which the first client of each group sends a solution of said problem to the second client of the group to which the client belongs (on the basis of address information of the second client),

a step in which the server sends all clients information requesting for evaluation of the solution and the evaluation standard information when performing the evaluation,

a step in which the second client sends to the first client evaluation information of the solution from the first client,

a step in which the server sends to at least one client belonging to the second group, a solution as a group conclusion of the first group,

a step in which the clients belonging to the second group discuss the solution from the first group by an internet conference and the like, and evaluation of the solution is determined, and

a step in which a representative client belonging to the second group transmits evaluation information by the second group to at least one client belonging to the first group.

Moreover, still another aspect of this invention is a method of information processing performed by an organized group which has a plurality of independent information processing means, the means individually having knowledge, knowledge expression, knowledge evaluation data, knowledge evaluation function, concept, algorithm of studies and the like (called knowledge in the following), the method comprising

a division process in which the information processing means are divided into a plurality of groups,

a successive first work process inside the group to draw a conclusion of the information processing result as the group, and

successively a second work process by the whole to derive the results of information processing as a whole organized group by integrating the results of information processing by said group, wherein

the division process is to divide into the groups so that differences in the results of information processing appear between the groups,

the first work process for each group is to advance work independently of other groups,

the second work process includes the first evaluation work process in which mutual evaluation of the results of other groups are made by using a common evaluation standard.

The second work process preferably comprises,

a second-first subset work process in which the information processing results of group are exchanged,

a second-second subset work process (the first evaluation work process) in which information processing results of other groups are evaluated independently in each group by use of the same evaluation standard,

a second-third subset work process in which the evaluation results are displayed, outputted and notified to other groups,

a second-fourth subset work process in which knowledge and the like possessed by each group, related to the evaluation results, are exchanged between groups,

a second-fifth subset work process in which based on knowledge possessed by other groups obtained by exchange, knowledge possessed by the group is revised, and

a second-sixth subset work work process to obtain information processing results of the whole where differences in information processing results of each group are within a range.

Also preferably the second work process comprises,

a second-first subset work process (first evaluation work process) in which information processing results as a group are exchanged,

a second-second subset work process (the first evaluation work process) in which information processing results of other groups are evaluated within the group independently by use of identical evaluation standards,

a second-third subset work process in which said evaluation results are displayed, outputted and communicated to other groups,

a second-seventh subset work process in which information processing results executed by other groups are intellectually nurtured,

a second-eighth subset work process in which said information processing results are nurtured by the group which originally brought forth information processing results intellectually nurtured by others in parallel and independently of the second-seventh subset work process,

a second-ninth subset work process in which the results of the second-seventh subset work process and the results of the second-eighth subset work process are exchanged,

a second-tenth subset work process in which the results of the second-seventh subset work process and the results of the second-eighth subset work process are evaluated based on the same evaluation standard,

a second-eleventh subset work process in which the evaluation results of the work process of the second-ninth subset are displayed, outputted and notified to other groups,

a second-twelfth subset work process in which, knowledge and the like possessed by each group related to said evaluation results are exchanged between groups, and on the basis of knowledge possessed by other groups obtained by exchange, knowledge possessed by the group is revised, and

a second-thirteenth subset work process in which information processing results as a whole are obtained where differences in information processing results of each group are within a range.

### BRIEF DESCRIPTION OF DRAWINGS

FIG. 1 illustrates the relations between each work in the method of information processing in an embodiment of this invention.

FIG. 2A describes the entire composition when there are processes which divide the whole organization in the embodiment of the method of information processing.

FIG. 2B describes the structure of work in the divided groups when there are processes which divide the whole organization in the embodiment of the method of information processing.

FIG. 3 describes the structure when there are no processes dividing the whole organization in the embodiment of the method of information processing.

FIG. 4 describes examples of combinations of the first and second works when the information processing method of the embodiments is applied to a digest discovery method.

FIG. 5 describes the process of information processing of one embodiment of information processing of the embodiments.

FIG. 6 describes the structure of information processing by a plurality of computer agents which is one example of embodiments of information processing of the embodiments.

FIG. 7A is a flow chart which shows each work step in the entity-dividing support method of the embodiment of the invention.

FIG. 7B is a flow chart which shows the steps to determine distance between groups in the entity -dividing support method.

FIG. 8 is an explanatory figure which shows dividing standard parameter and weighted coefficients to explain the entity-dividing support method of the embodiment.

FIG. 9 is an explanatory figure which shows part of the entity-dividing support method process of the embodiment.

FIG. 10 is an explanatory figure which shows part of the entity-dividing support method process of the embodiment.

FIG. 11 is an explanatory figure which shows part of the entity-dividing support method process of the embodiment.

FIG. 12 is an explanatory figure which shows part of the entity-dividing support method process of the embodiment.

FIG. 13 is an explanatory figure which shows part of the entity-dividing support method process of the embodiment.

FIG. 14 is an explanatory figure which shows part of the entity-dividing support method process of the embodiment.

FIG. 15 is an explanatory figure which shows part of the entity-dividing support method process of the embodiment.

FIG. 16 is an explanatory figure which shows part of the entity-dividing support method process of the embodiment.

FIG. 17 is an explanatory figure which shows part of the entity-dividing support method process of the embodiment.

FIG. 18 is an explanatory figure which shows a concrete example of a maximum distance between group pairs table of the entity-dividing support method process of the embodiment.

FIG. 19 is an explanatory figure which shows the dividing standard parameter and weighted coefficients of another concrete example of the entity-dividing support d method of the embodiment.

FIG. 20 is an explanatory figure which shows part of the entity-dividing support method process of the embodiment.

FIG. 21 is an explanatory figure which shows part of the entity-dividing support method process of the embodiment.

FIG. 22 is an explanatory figure which shows a concrete example of a maximum distance between group pairs table of the entity-dividing support method process of the embodiment.

FIG. 23 is a block diagram which shows the composition of the entity-dividing support device.

FIG. 24 illustrates the computer network system which supports the embodiment of the method of information processing of this invention.

FIG. 25 shows an example of the flow chart of the embodiment.

FIG. 26 illustrates concrete examples of various sheets used at the meeting center of the embodiment.

FIG. 27 illustrates concrete examples of various sheets used by each client when the method of information processing of the embodiment is supported by a computer network system.

FIG. 28 illustrates concrete examples of various other sheets used by each client when the method of information processing of the embodiment is supported by a computer network system.

FIG. 29 illustrates concrete examples of various other sheets used by each client when the method of information processing of the embodiment is supported by a computer network system.

FIG. 30 illustrates concrete examples of various other sheets used by each client when the method of information processing of the embodiment is supported by a computer network system.

FIG. 31 shows exchange of information between 3 clients in the method of supporting the method of information processing of the embodiment by a computer network system.

### EMBODIMENT OF THE INVENTION

In the following, the principle of the method of information processing of this invention will be explained in detail, suitably including examples of actual applications, while being compared with a conventional method.

In general, cognition of knowledge may be recognized thoroughly, clearly and accurately by comparison with knowledge different from the recognized knowledge. Moreover, this knowledge entity becomes clear by comparison with knowledge which differs greatly therefrom. Based on this principle, the inventor devised the following individual-whole system as a highly efficient information processing method to improve productivity.

That is, the basis is to divide an organized group which consists of information processing means (people, or computer agents) into a number of groups so that they differ, to have the divided groups execute information processing work independently and to mutually evaluate the results of work based on the same evaluation standard. And, the evaluation is to clearly display and/or indicate when the results of work by other groups will not meet evaluation standards, or to state that they are superior to work results of their own group and to thereafter foster the work results of a different group by their own group.

Also, work in each the group will start from individual work of each means of information processing and will include mutual evaluation of the results based on the same evaluation standard of the group. This evaluation is to display and point out clearly that work results by other information processing means fails to meet evaluation standards or to state that they surpass their own work results and to then foster work results of other information processing means by themselves.

Even when the organized group is not divided into groups, the method is for the work of each information processing to be made independently and to have a process for evaluating work results of each other by the same evaluation standard as a whole. This evaluation standard is similar to the above, to display and point out clearly when work results by other information processing means fail to meet evaluation standards or to state when they surpass their own work results and to then foster work results of other information processing means.

In the following, the process will be explained in detail.

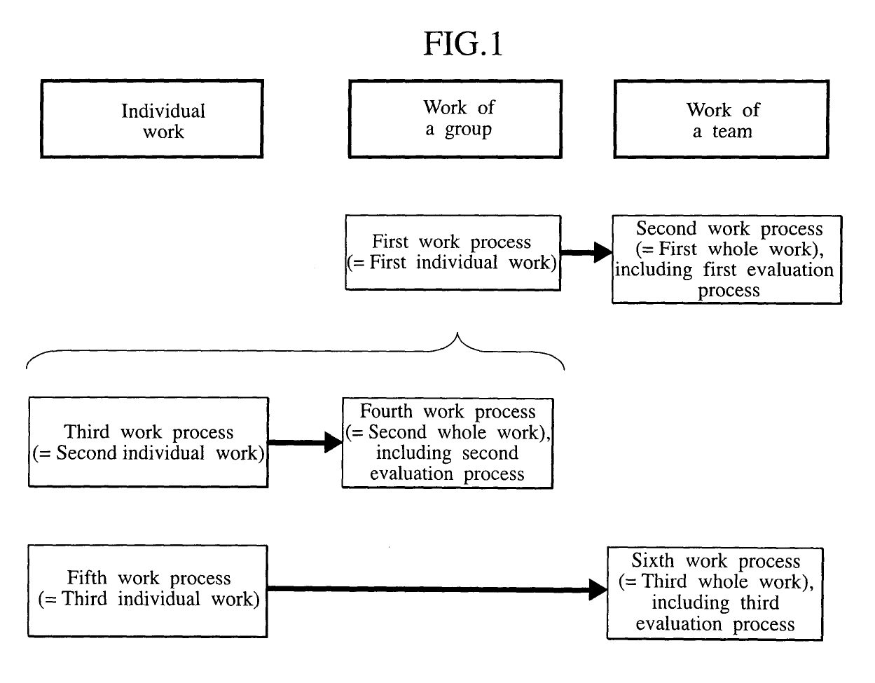

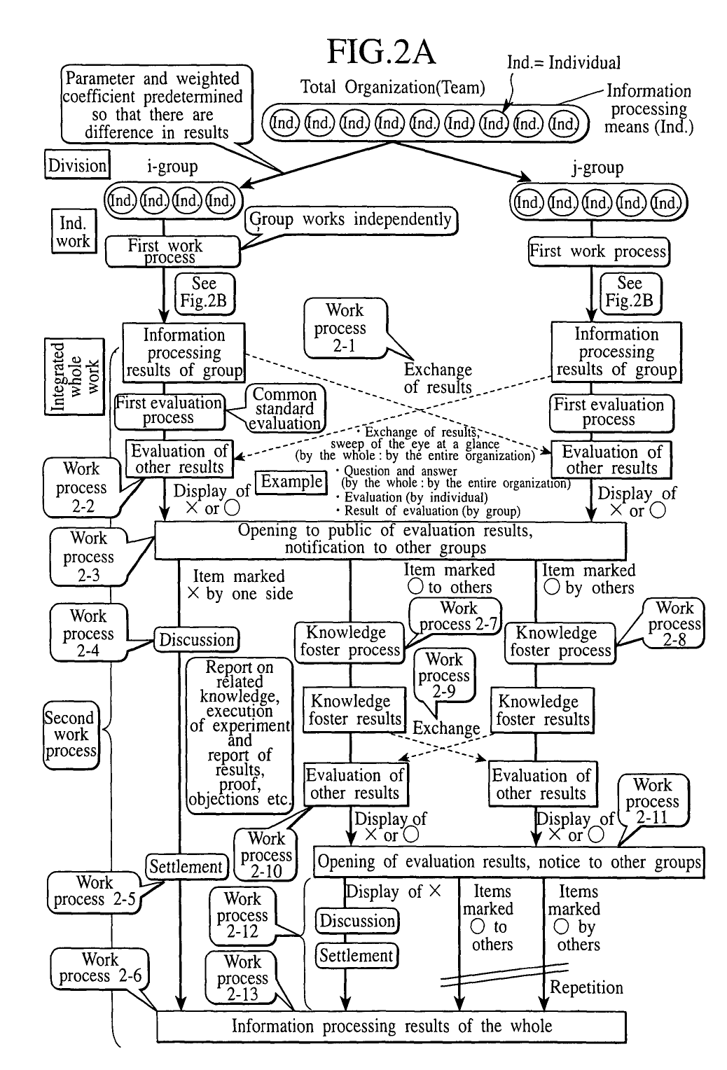

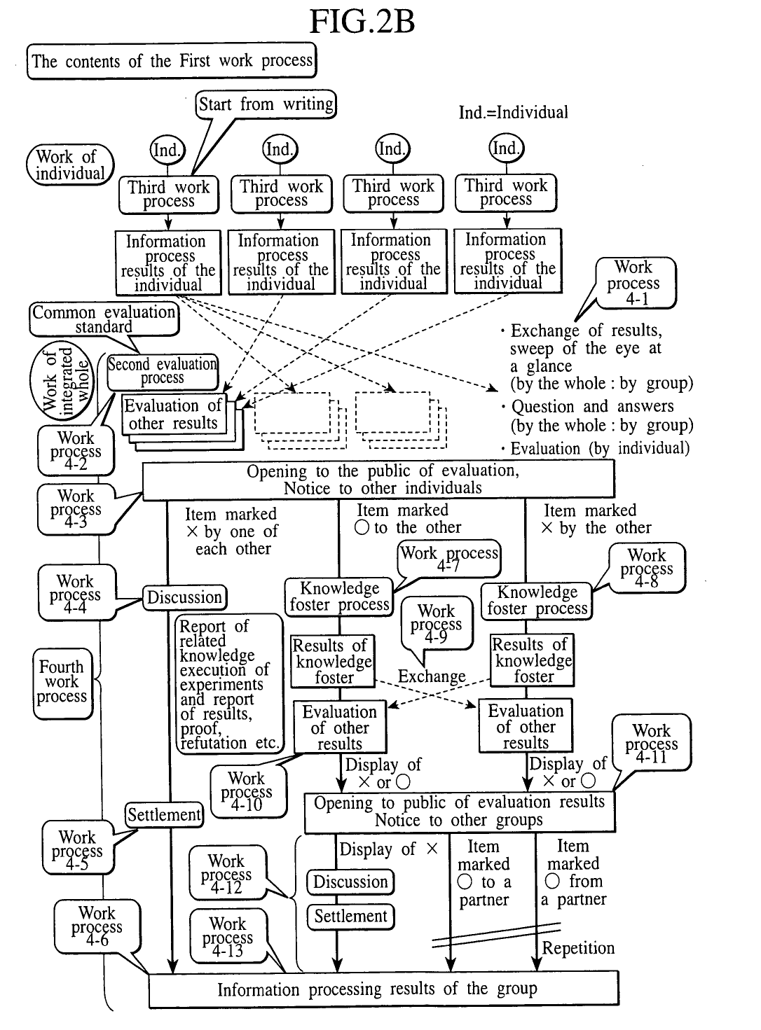

FIG. 1 is a conceptual figure which shows the process of the individual-whole system of the present invention. Also FIG. 2A, FIG. 2B show the total figure of the individual-whole system with dividing processes and a sectional figure which shows the work inside the divided group. FIG. 3 shows the total figure of an individual-whole system which does not have dividing processes.

Firstly the process of the individual-whole system with dividing processes will be explained.

Firstly, as shown in FIG. 2A, the organization group (team) is divided into several groups. In doing so, the division is made so that there will be differences in the work results of the groups. Each group will then conduct information processing on the same theme or subject independently (first work process=first individual work process).

Then, as shown in FIG. 2B, the work in each group will start from descriptive (“writing”) work as the individual work process (third work process=second individual work process). For instance, descriptions of various knowledge (situation, subject, questions and the like) are provided which relate to the object of information processing.

As the first step (the fourth-first subset work process shown in FIG. 2B) of the entire work process of the group (fourth work process=second whole work process), the written paper should be posted so that everybody may see it at a glance. And, if necessary, questions and answers by each other can be made on the contents written on the posted paper if it is unclear.

Next, as the second step of the entire work process of the group (the fourth-second subset work process of FIG. 2B), evaluation will be made (second evaluation process). That is, notifying and displaying that the work results performed by other information processing means are not in accord with the evaluation standard (the fourth-third subset work process shown in FIG. 2B).

To be concrete, for instance, the notifying and displaying comprises marking a X sign (desirably displayed in red to be stimulative). Work indicating not being in accord with the evaluation standard will be called “X strike”.

Or a display will be made that in view of the evaluation standard, the work results performed by other information processing means excels (one's own work results). To be concrete, a ◯ sign (for instance in green and the like) will be marked on a paper written by another person. Work indicating superiority will be called “◯ strike”. Here the evaluation will be made individually and independently (not by consultation but at one's own discretion).

Thus, the evaluation standard will be identical within the group.

As an example of this evaluation standard, there is a method to fill up “a gap between a desirable state and the present state”. For example, “something not in accord with a policy of development of work (information processing)” or “something which differs from the truth” and the like may be mentioned.

Also in order to make distinct the own work results and those of others, a standard which differs from one's own work result may be set up. For instance, it is “something different from our investigation results” and the like.

These evaluation standards may be changed appropriately in accordance with object and situation, which may be determinesd by the leader of the group, or in some cases by members of the group. When the information processing means is a computer or a computer agent, from options determined beforehand for each process or according to the contents of the information processing work, the information processing means itself may determine the change as an organized group.

Also, the methods for “X strike” and “◯ strike” may be indications of differences and errors, display, negation and warning or display of praise, agreement and the like to information displayed in a report or a memorandum which shows the work results of each information processing means or information displayed on electronic information media.

More concretely, the writing or display of a X sign, a ◯ sign or a variety of lines, words, pictures, colors or the generation of sounds of buzzers, sirens and voices, or the lighting of lamps and the like, the presentation, notice or cards, signboards, seals, papers, flashing or the change of a display color or the change of fonts on part of or an entire screen of an electronic information display devices may be used singly or in combination. However, in all cases, it is necessary that what was evaluated must be clearly informed to the person.

For instance, besides the method of entering a X sign or a ◯ sign on the paper of the report document prepared by some other individual, for example a red seal (signifies X) or a green seal (signifies ◯) may be applied and, in addition, the name of the evaluator may of course be indicated on the seal.

Also, in the evaluation process, the person who prepared the information and the evaluator may be kept anonymous or the evaluation may be made in a place where the person who prepared the information is not present. This is to ensure fair evaluation by separating the person who wrote the content and the written content.

Then, after the X strike, the individual who applied a X and the individual who received the X will discuss the propriety (the fourth-fourth subset work process shown in FIG. 2B) and settle the problem (the fourth-fifth subset work process shown in FIG. 2B).

Then, the result brought forth by applying the X and discussion afterwards will be the result of the group (the fourth-sixth subset work process shown in FIG. 2B).

The case where ◯ is applied will now be described. In this invention, in case when the work result of another person (called B) is, upon comparison with the evaluation standard, superior (better than the work result of A), the evaluator (called A) will express this by applying a ◯ (the 4-3 work process in FIG. 2B), and afterwards A will execute a process of knowledge foster which aims at making the work result of B more superior (the fourth-seventh subset work process in FIG. 2B). For instance, when the work result of B is a countermeasure plan, A will make a countermeasure plan (independent of B) which should be better. In parallel, B will make a plan (independent of A) where his countermeasure plan is improved (the fourth-eighth subset work process in FIG. 2B). The plans will then be exchanged (the fourth-ninth subset work process in FIG. 2B) and will be evaluated again based on an evaluation standard appropriately determined (the fourth-tenth subset work process in FIG. 2-B) which will be opened to the public and exchanged (the fourth-eleventh subset work process in FIG. 2-B) and will be discussed and settled (the fourth-twelfth subset work process in FIG. 2B). The process of the above will be repeated. The number of repetitions may be set appropriately or may be repeated until the difference in results becomes smaller than a level. The conclusion of the group will be derived in this way (the fourth-thirteenth subset process in FIG. 2B).

In the knowledge foster process, for instance at least one composition element of the digestive-discovery method which will be described later or a countermeasure-creation-work process or a process-reproduction-work process (process reproduction method) where facts related to the object generated in the past are reproduced as drawings, composition and the like, reproduction-experiment-work process (reproduction experiment method) where reproduction experiments are made based on information of the object, object-watching-work process (object watching method) where information related to the object expressed by drawings, writings and the like by watching the situation of the object partially, the self-objectification work process (self-objectification method) where information related to information processing processes executed in the past are reproduced by drawings, writings and the like, action-experiment-work process (action experiment method) which increases information from the results of experiments executed, and thought-experiment-work process which increases information from results of thought experiment executed (thought experiment method includes: performance method, host-guest displacement method and the like), may be used. By this, with the aim of at work results superior to the initial work results of B, and A and B may execute information processing independently.

In the object-watching-work, the situation of the object related to the theme will be observed partially and will be expressed by actual things or video images and the like, or in a type of information indication, such as pictures, drawings and writings. In the self-objectification work, the action of oneself (subject) or oneselves will be reproduced in drawings and writings and will be seen by a sweep of the eye as though it were an object and its contrivance will be investigated. As one example of thought-experiment-work, a method in which information related to the theme is processed by the thought experiment, by changing the standpoint which differs from their own including the object or something else and actually performing, may be used. As a concrete example, a role performance method where individuals (or groups) will each prepare ideas based on the different viewpoints assigned to individuals (or group) based on the viewpoint of “different opinions” submitted from each information processing means (each individual) or groups, or a host and guest displacement method where various information will be analyzed from the standpoint of the object, can be used.

The aforementioned knowledge foster process includes increasing, decreasing or amendment of items of data or glossary related to the object, or their relation, relation strength coefficient, and valuation coefficient.

As described, in this invention a “X strike” (work which displays not in accord with the evaluation standard) or “◯ strike” (work which displays superiority) are executed on the individual information processing results. As a result when X is applied, diversification of viewpoint will be promoted and by deep discussions by debating with each others knowledge and the like, the quality of the information processing will improve and, at the same time, joint ownership will be advanced and as a result the efficiency of information processing will be heightened. Also when ◯ is applied, it will not be an easy judgement as the side who made the evaluation has an obligation to promote it to higher levels and the efficiency of the information processing will be increased as the side who originally derive the work result will have to work to compete with the result and increase it to higher levels.

In this way, by promoting grouping and integration to groups from individuals, the conclusion of the group will be derived (work process No. 4-6 or No. 4-13 shown in FIG. 2B).

Also, in the present invention, the results of each group will be exchanged mutually (work process No. 2-1 shown in FIG. 2A) and afterwards the results will be evaluated by the same standards (first evaluation process). Similarly a “X strike” or a “◯ strike” will be made.

Here, it is better for each individual to first make an evaluation (strike X or ◯) and to determine based on this result the evaluation result (X or ◯) of the group.

The evaluation results of the group will be discussed between groups (work process No. 2-4 shown in FIG. 2A) and a conclusion will be made (work process No. 2-5 in FIG. 2A). That is, one who was evaluated X will be given the reason and proof why X was applied or may refute or object thereto, and the results will be settled as the entire organized group, and the work result of the entire organization which integrates the group work results will be derived (work process No. 2-6 in FIG. 2A).

Also for those evaluated ◯, both groups will foster knowledge related thereto, independent of each other (work processes No. 2-7 and No. 2-8 in FIG. 2A) and will exchange the results (work process No. 2-9 in FIG. 2A) and will both evaluate each other (work process No. 2-10 in FIG. 2A) and will open and notify the results (work process No. 2-11 in FIG. 2A). These will be discussed and settled (work process No. 2-12 in FIG. 2A). These processes will be repeated and the work result of the entire organization will be deduced (work process No. 2-13 in FIG. 2A). The number of repetition may be set suitably and also a method of repeating until differences in the results become smaller than a level may be taken.

In this way, the results of the whole organization of integrated groups will be deduced (work process No. 2-6 or 2-13 in FIG. 2A).

Here the method of the X strike and the ◯ strike in the first evaluation work process may be made similar to the method of a X strike and a ◯ strike in the second, third evaluation work processes.

The relation between each work in the individual-whole system executed in this manner is as shown in FIG. 1, FIG. 2A, FIG. 2B.

Also in the information processing method (individual-whole system), a method of grouping and integration directly from individual to the whole without initially dividing individuals into groups may be taken where the method of grouping and integration from individuals to groups described above may be used directly.

The relation between each process in this case is shown in the relation between FIG. 2B and FIG. 3.

The information processing work executed by the individual-whole system described above is concretely a production activity executed in a field of business, work, planning, manufacture, sales, service, investigation, research, development, study, education, training activity and the like in an organization of an enterprises and the like, and includes understanding the situation of the object and information processing related to correspond to the object.

The digestive-discovery method described below may be taken as a concrete example of information processing to which the individual-whole system of the present invention is applied.

That is, it includes an information sweep of the eye at a glance work process whereby information related to the object is arranged and displayed so that the information can be seen at a glance, an extraction work process of indistinct points whereby things of the object which cannot be understood are extracted, an investigation items arrangement work process whereby investigation items are extracted and arranged, a hypothesis preparation work process whereby hypotheses are prepared, an investigation work process whereby hypotheses are actually inspected and verified, and a discovery work process whereby discovery related to the arrangement of the object will be made and based on this a countermeasure creation work will be conducted to create countermeasures to the object.

As for the information sweep of the eye at a glance work process, when the information processing means is a computer or a computer agent, the work process will be housing of the database which the entire organized group owns jointly.

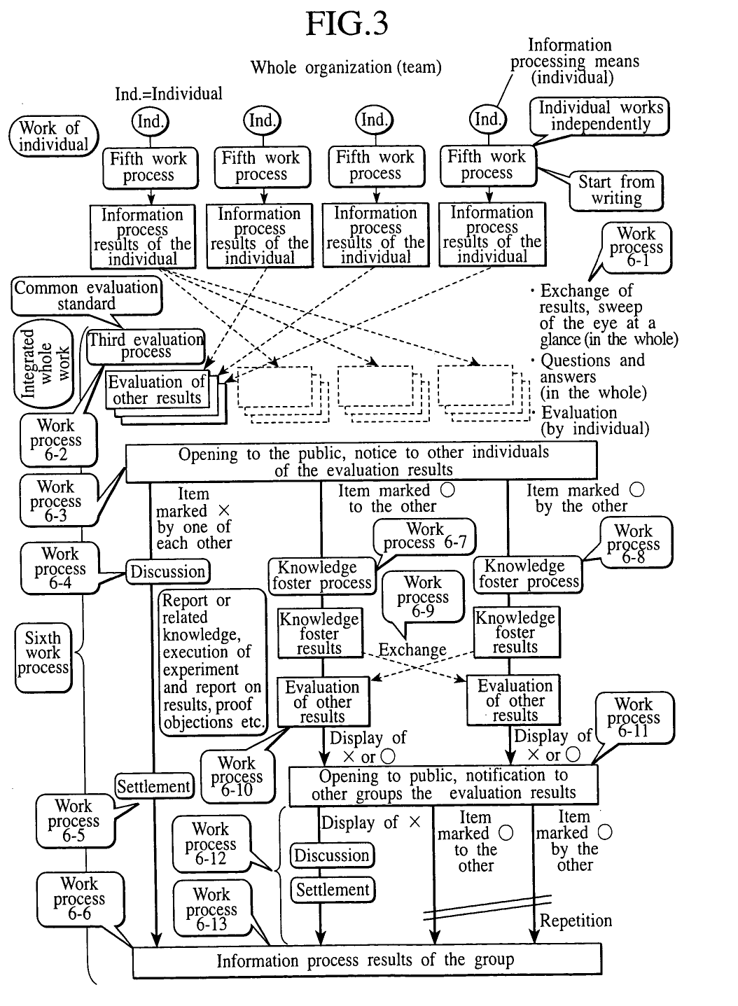

In applying the individual-whole system to the digestive-discovery method, it is effective for the leader of the entire organized group (will be called “team” here after) to first divide the entire group into groups. This is illustrated in FIG. 4, three kinds (case-A to case-C) of representative combinations of individual work of a group (work in the divided group) and whole work as a team (work in the entire organization) in executing the digestive-discovery method are shown in FIG. 4.

Here, as mentioned before, when dividing the information processing means into groups, it is necessary that there is a difference in the results of information processing between groups. As a concrete method to realize this, a method of division where there will be a difference in characteristics of the information processor may be used.

When the information processing measure is a computer or a computer agent, regarding knowledge and the like, or database, knowledge, knowledge expression, knowledge evaluation data, knowledge evaluation function, concept, learning algorithm and the like as noteworthy characteristics, or when they have a genetic algorithm, regarding the kinds and contents of information processing made in the past as noteworthy characteristics, a division is made so that they differ.

Also in case the information processing means is a human being, the noteworthy characteristics may be technical aspects such as knowledge of the “object” each information processor has, characteristics on a mental side such as extent of interest in the object and zest towards the object, experience related to the object and number of years of experience and position or role in an organization with information processing means of, age, sex, character, home address, customs, place of birth, professional knowledge, academic background and the like or attitude and behavior at work (talkative or not, whether the person speaks out and acts positively or not, ambitious or not) or the mode of conduct (whether the person has a sharp view of the theme or not and the like).

The above data may be collected from information from the person concerned or surrounding persons or through a questionnaire with adequate question contents from the person concerned or surrounding persons or from results of observation of the person concerned practiced by surrounding persons.

The present invention also provides a more reliable and quantitative method of the division to a plurality of groups. That is, dividing standard parameters which characterize the information processing means are extracted and the “weighted coefficient” of each parameter is fixed.

Here the dividing standard parameters are, for example, as before, knowledge and the like which they possess, that is, database, knowledge, knowledge expression, knowledge evaluation data, knowledge evaluation function, concept, algorithm of learning and the like or, in case that they comprise genetic algorithm, the kinds and contents of information processing in the past maybe used. Also it maybe “age”, “sex”, “character”, “present home address”, “customs”, “place of birth”, “professional knowledge”, “academic background” or “attitude” or “behavior” during work of the information processing means (talkative or not, whether the person speaks out and acts positively or not, ambitious or not, and the like), or “the mode of conduct” (whether the person has a sharp view of the theme or not, and the like). From these characteristics, ones which are deemed to be important may be extracted as a dividing standard parameter.

Also, the “weighted coefficient” indicates the importance of the plurality of extracted dividing standard parameters. For instance, when a parameter A and a parameter B are chosen as the dividing standard parameters of evaluation, if the parameter A is considered to be more important, the “weighted coefficient” of parameter A will be set to “5” and “weighted coefficient” of parameter B will be set to “1” according to their relative importance.

By extraction of dividing standard parameters and fixation of “weighted coefficients”, evaluation will be made for each parameter of each information processing means. And grouping will be made so that the value of the evaluation value multiplied by the “weighted coefficient” will differ between groups as much as possible.

In doing so, for each information processing means, the sum of evaluation value of all parameters will be obtained and the group may be divided according to the sum value or the information processing means may be divided into several large groups on the basis of the evaluation value of some parameter and furthermore these large groups may be divided into a plurality of smaller groups based on another parameter.

The leader who performs the group division may appropriately change the dividing standard parameters and the “weighted coefficient” and recalculate the evaluation value and thereby determine the method of division that gives differences in the sum of evaluation values between groups.

The extraction of dividing standard parameter, fixation of “weighted coefficient”, calculation of evaluation valuation and combination when dividing into groups may be executed efficiently by use of tools consisting of a variety of mediums of predetermined formats with a column for dividing standard parameter and a column for “weighted coefficient”.

Also extraction of dividing standard parameters, fixation of “weighted coefficient”, calculation of evaluation value and combinations when dividing into groups may be executed rapidly and reliably by a computer. Concrete methods will be explained in the following.

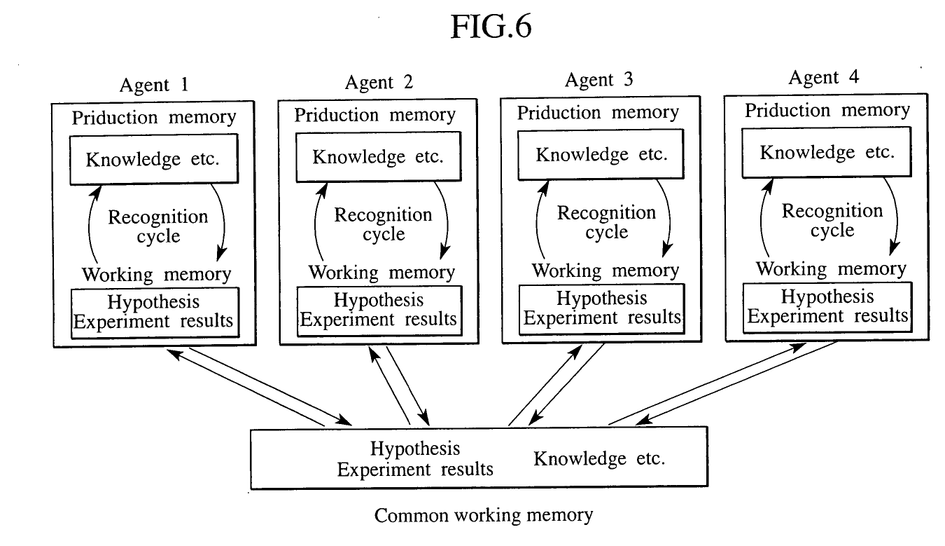

FIGS. 7A and 7B are flow charts which show the method or process of the division.

In this embodiment, this process will be executed by a computer program.

This process generally includes the following steps.

(a) Step S01 in which ID and attribute (dividing standard parameter) of a plurality of entities (worker) is inputted to a computer.

(b) Step S02 in which values of each entity are inputted to the computer or calculated by the computer.

(c1) Step S13 in which the entities are divided into a plurality of groups by a plurality of modes or methods by the computer.

(c2) Step S15 in which division IDs are given to the division modes or methods by the computer.

(d) Step S17 in which average values and deviations of attributes of plural entities of each group belonging to each division ID are calculated by the computer.

(e) Step S19 in which at least one group pair is generated by the computer from a plurality of groups belonging to each division ID.

(f) Step S21 in which the distance between the group pair is calculated by the computer on the basis of the attribute average values and attribute deviations of the group belonging to the group pair.

(g) Step S31 in which after the computer repeats the steps (c) and (f) on a plurality of division IDs with which the plurality of entities are divided into the same number of groups, for each division IDs with which the division into the same number of groups is made, the group division ID which includes group pairs where the distance between group pairs is maximized is determined.

(h) Step S08 in which for each division IDs with which the entities are divided into the same number of groups, the division ID which includes the group pair where the distance between group pairs is the maximum is displayed on a display device with the maximum value.

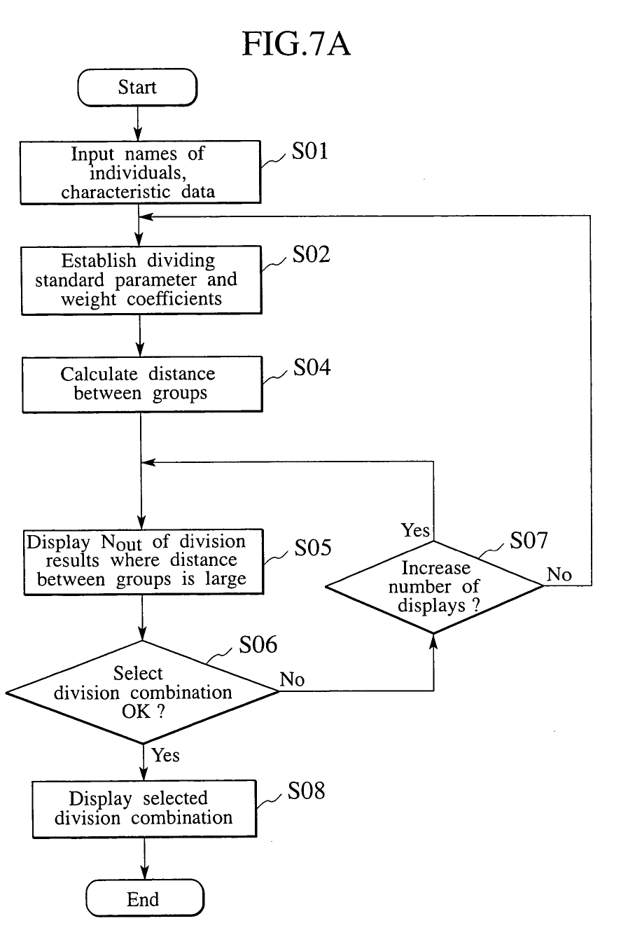

In the following, the process will be explained in detail by a division example of eight workers A-H shown in FIG. 8.

In step S01, ID and attributes of the workers (entities) are inputted to the computer. For instance, the name of the worker (or ID of names and the like by which the individual may be specified) and characteristic data (attributes) of the worker are inputted.

The characteristic data of the worker may be acquired from corresponding data of a suitable database. In more detail, for example as the “individual character data chart” 901a shown in FIG. 8, names A-H of the individuals may be inputted and corresponding characteristic data or attributes (in this case continuous service years, charge of business, conduct pattern, character, physical strength) may be provided.

Instep S02, the characteristic data shown in 901a of FIG. 8 is expressed by a numerical value as shown in table 901b of FIG. 8. In the following, this value is referred to as an original attribute value or a dividing standard parameter (or a division evaluation parameter).

Also, weighted coefficients will be established in step S02. In more detail, as shown in table 901b of FIG. 8, four items, continuous service years, business in charge, conduct pattern, and character are chosen as dividing standard parameters and the weighted coefficients for each parameter are, for instance, set as 8, 8, 4 and 3 (there is a characteristic “physical strength” in the “individual character data chart” 901a, but it was not chosen as a dividing standard parameter in table 901b as it was judged inappropriate as a dividing standard).

On the basis of each data of table 901b, values obtained by multiplying the original attribute value by weighted coefficients are shown in table 901c of FIG. 8. From here on, these numbers will be called “attribute value”.

In step S04, in addition to dividing individuals into various groups, difference in characters of the divided groups will be calculated as the difference in the total attribute value of the worker belonging to the group.

FIG. 7B is a flow chart which shows the process of step S04 in more detail.

In step S11, the number of divisions n of the entity will be set as 2.

In step S13, the whole number of people Nₜ (in the example of FIG. 8, 8 people) is divided into N_{g} (here 2) groups by various kinds of modes or methods.

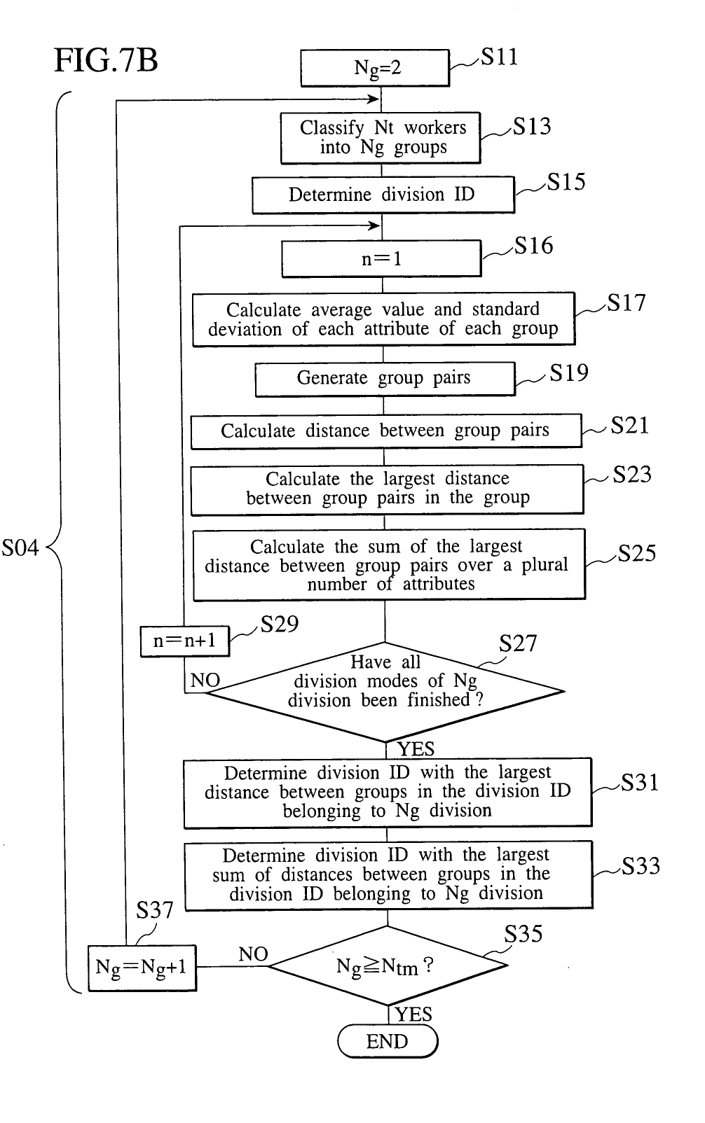

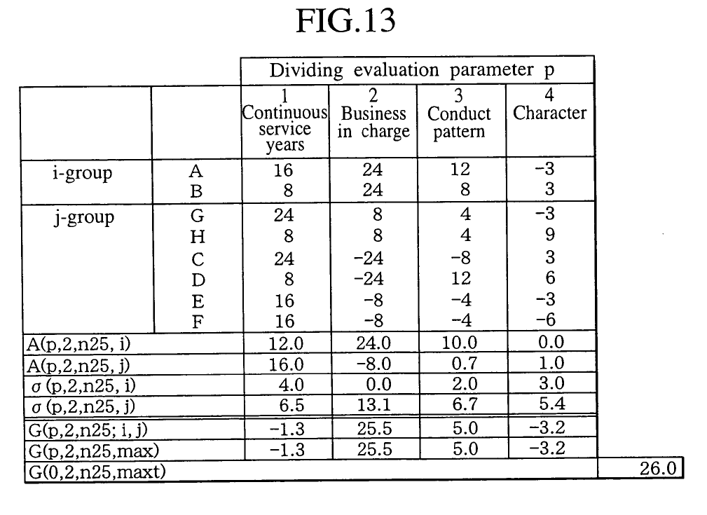

FIG. 9-FIG. 13 show examples of various modes or methods of dividing workers A-H of FIG. 8 into 2 groups. For instance, FIG. 9-FIG. 12 show the modes or methods of dividing workers A-H into groups with 4 persons and FIG. 13 shows an example of dividing the workers to groups of 2 and 6 people.

In step S15, an ID is given to the division mode or division method in order to specify each mode or method (from hereon, this will be called division ID). This division ID will be expressed as <N_{g}, n>. Here N_{g} indicates the division number of the entity, n indicates that it is the nth combination of the division combination.

In step S16, in order to examine the first division mode, (for instance, division mode shown in FIG. 9: ABDH;CEFG) the division mode number will be set as n=1.

In step S17, in the first division ID (<N_{g}=2, n=1>), the average value A(p,N_{g},n,i) and standard deviation σ (p,N_{g},n,i) of each attribute p of each divided group i will be obtained.

For instance, in the example shown in FIG. 9, the average value of continuous service of the i group will be calculated as 10.0, and the average value of continuous service of the j group will be calculated as 20.0. Also the standard deviation of the continuous service of the i group will be calculated as 3.5 and the standard deviation of the continuous service of the j group will be calculated as 4.0.

In step S19, group pairs will be generated from groups belonging to each division ID. Here, in a case where an entity is divided into two groups, only one group pair is generated.

In step S21, the distance between the generated group pairs will be calculated on the basis of an average value A and standard deviation σ of each group.

Here, the distance G(p,N_{g},n,j) between group pair i-j is defined, for example, as,

G(p,N_{g},n;i,j)=[|A(p,N_{g},n,i)−A(p,N_{g},n,j)|−(σ(p,N_{g},n,i)+σ(p,N_{g},n,j))/2]

(this distance G(p,N_{g},n;i,j) maybe displayed as Gp,N_{g},n,(i,j) in figures).

In the example shown in FIG. 9, the distance between group pair G for continuous service is calculated as being 6.3, the distance between group pair G for business is calculated as being 0.5, the distance between group pair G for conduct pattern is calculated as being 8.2, and the distance between group pair G for character is calculated as being 2.1. Also n21 in G(p,2,n21;i,j) of FIG. 9 indicates the division number of this division mode (the same in following examples).

In step S23, for each attribute, among group pairs which belong to the division ID, the group pair where the distance between the group pairs is maximum and the maximum value max{G(p,N_{g},n;i,j)} will be determined. (This maximum value max{G(p,N_{g},n;i,j) maybe written G(p,N_{g},n,max) in the figures.)

When the division number N_{g} is 2, the number of group pairs will be 1 as before, and this one group pair will be the group pair with the largest distance between group pair (for each attribute). Therefore in the example shown in FIG. 9, for instance for continuous service, the maximum value max{G(p,N_{g},n;i,j)} will be determined as 6.3. As will be mentioned later, the process of this step S23 will be useful for a case where the number of group pairs belonging to division ID is more than 2.

In step S25, the largest distance between group pairs max{G(p,N_{g},n;i,j)} of each the attribute will be added over a plurality of attributes p and the sum of the largest distances between group pairs Σₚmax{G(p,N_{g},n;i,j)} will be obtained (this sum of largest distances between group pairs Σₚmax{G(p,N_{g},n;i,j)} may be displayed as G(p,N_{g},n,maxt) in figures).

In the example shown in FIG. 9, the sum of largest distances between group pairs Σₚmax{G(p,N_{g},n;i,j)} is calculated as being 17.1.

In step S27, it will be checked whether the largest distance between group pairs max{G(p, N_{g}, n;i, j)} and the sum of largest distance between group pairs Σₚmax{G(p,N_{g},n;i,j)} for each attribute has been obtained for all division modes with the division number N_{g} (for instance 2). If the largest distance group pairs of each attribute max{G(p,N_{g},n;i,j)} and the sum of the largest distances between group pairs Σₚmax{G(p,N_{g},n;i,j)} has not been obtained, n will be increased by 1 in step S29 and will return to step S17.

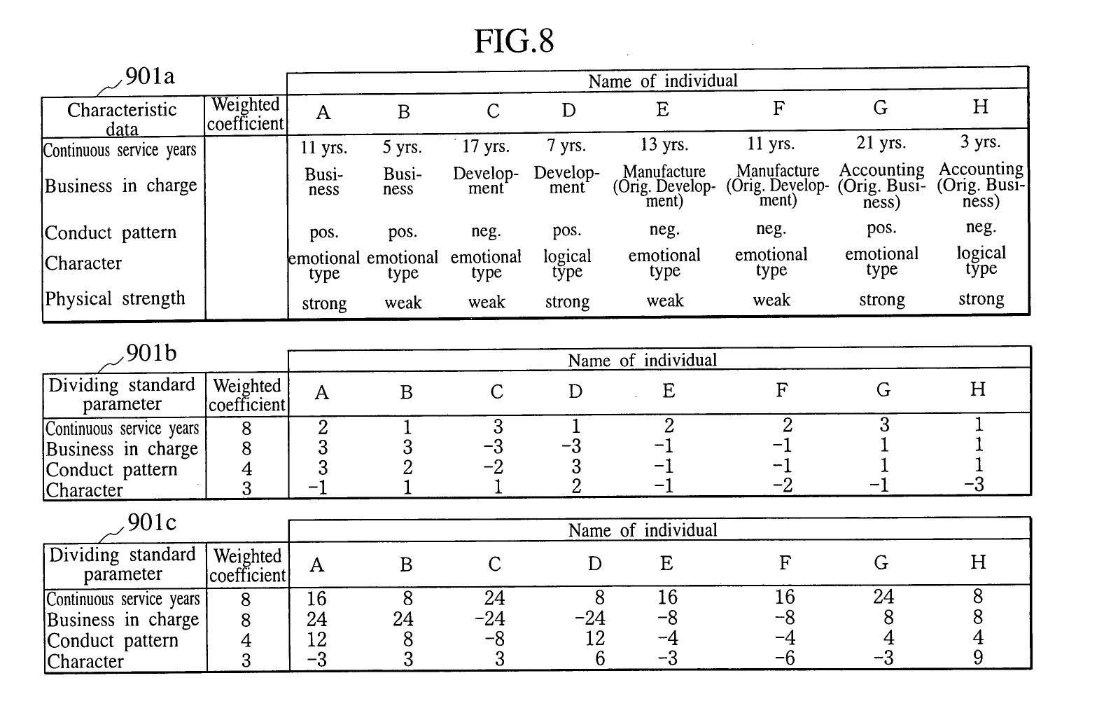

And, for the next division mode (for instance division mode shown in FIG. 10), the largest distances between group pairs max{G(p,N_{g},n;i,j)} and the sum of largest distances between group pairs Σₚmax{G(p,N_{g},n;i,j)} for each the attribute will be obtained.

In this way, for division number N_{g}=2, together with the division mode shown in FIG. 9, for division modes shown in FIG. 10 and FIG. 13 and the like, the largest distance between group pairs max{G(p,N_{g},n;i,j)} and the sum of largest distances between group pairs Σₚmax{G(p,N_{g},n;i,j)} for each attribute will be obtained.

In step S27, when it is judged that the largest distance between group pairs max{G(p,N_{g},n;i,j)} and the sum of largest distances between group pairs Σₚmax{G(p,N_{g},n;i,j)} for each attribute has been obtained for all division modes with the division number N_{g} (for example 2), procedure will be made to step S31.

In step S31, for each attribute p, of all division modes (with the division number N_{g} (for example 2)), the division mode (division ID) where the largest distance between group pairs max{G(p,N_{g},n;i,j)} becomes largest will be determined.

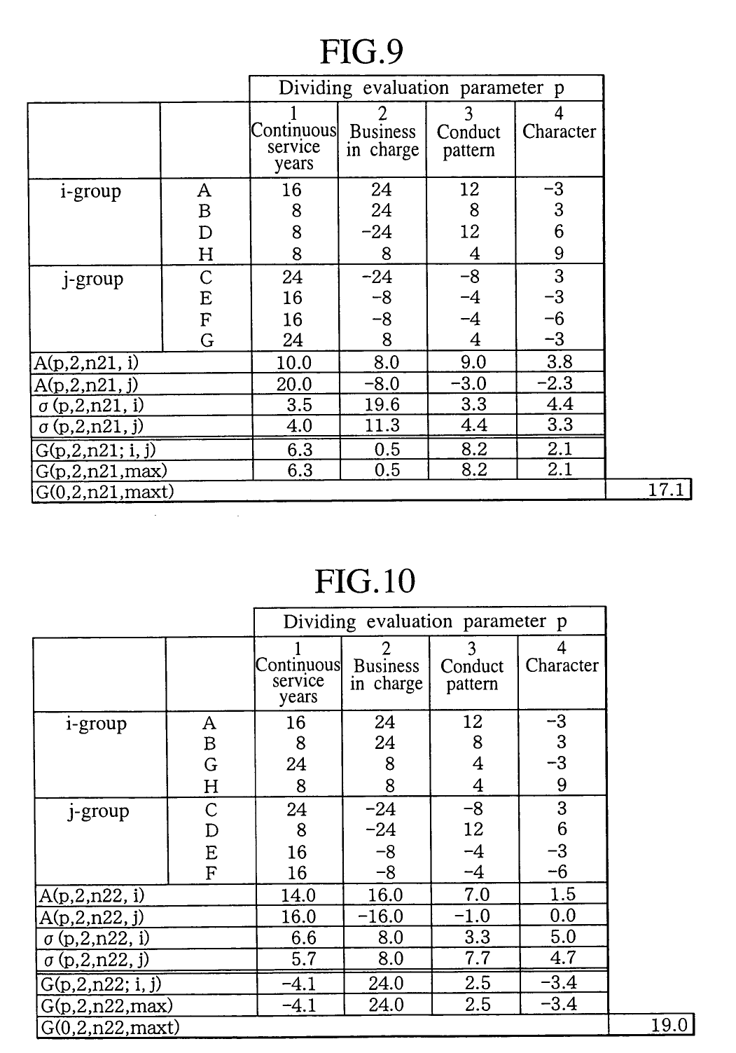

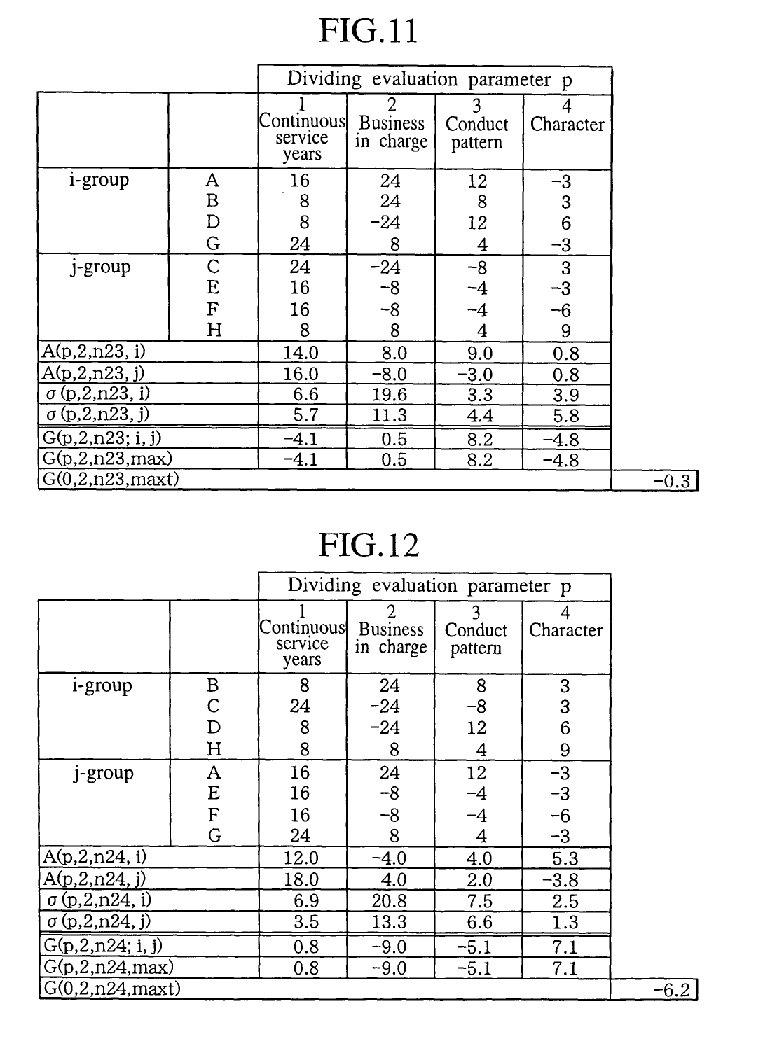

For example, when the division modes shown in FIG. 9-FIG. 13 are all division modes with division number 2 (it is actually not so), the maximum value of number of years of continuous service as an attribute p will be 6.3 and its division mode will be determined to be as shown in FIG. 9. Similarly, the maximum value of business in charge will be 25.5 and its division mode will be determined to be as shown in FIG. 13. The maximum value of conduct pattern will be 8.2 and its division mode will be determined to be as shown in FIG. 9 and FIG. 11. The maximum value of character will be 7.1 and its division mode will be as shown in FIG. 12.

In step S33, of all division modes (with the division number N_{g} (for example 2)), the division mode (division ID) where the sum of largest distance between group pairs Σₚmax{G(p,N_{g},n;i,j)} is maximum will be determined.

For instance, in the case where the division modes of FIGS. 9-13 are all division modes with division number 2, the largest value of the sum of largest distances between group pair Σₚmax{G(p,N_{g},n;i,j)} will be 26 and its division mode will be determined to be as shown in FIG. 13.

In step S35, it will be judged whether the division number N_{g} is, with respect to the number of entities (workers) Nₜ, equal to or more than the largest natural number Nₜₘ which is less than or equal to (Nₜ+1)/2, and if no, advancement will be made to step S37 and the division number N_{g} will be increased by 1 and will go back to step S13.

Hereon, in step S13, the workers A-H will be divided into the group with an increased division number N_{g} (for instance 3).

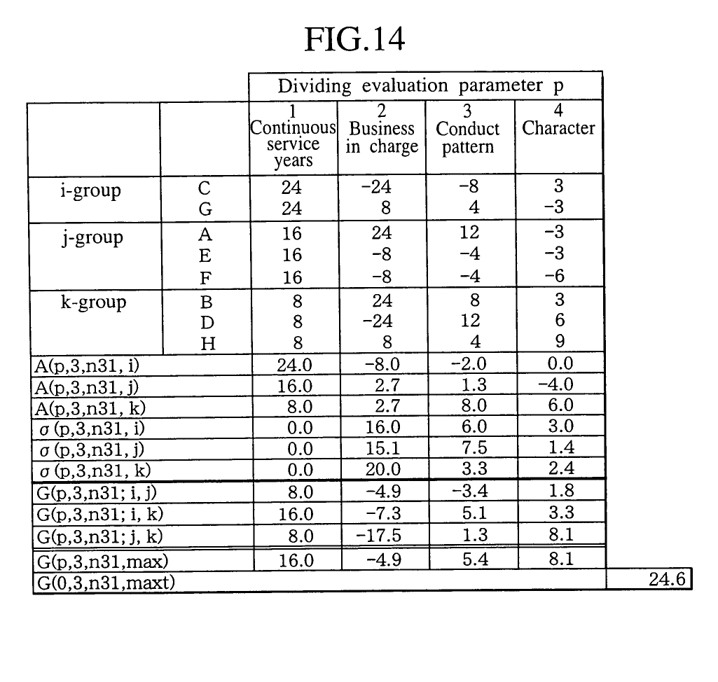

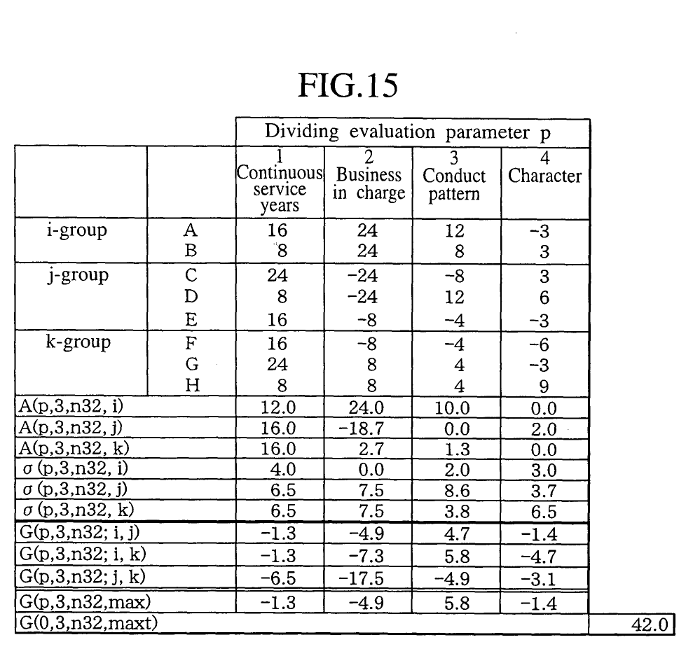

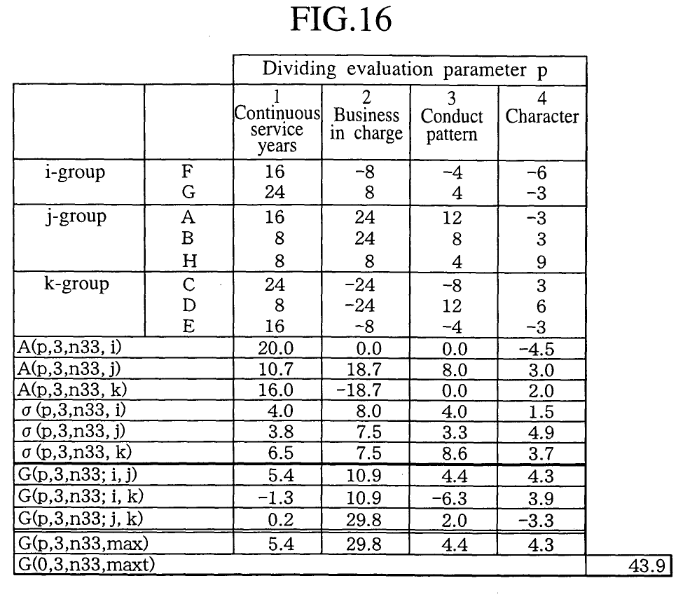

FIG. 14 to FIG. 17 show examples of dividing the workers A-H to 3 groups.

In step S15, similar to the case of the division 2, a division ID will be given to each division mode, and in step S16 the first division ID will be established, and in step S17, the average value and standard deviation will be calculated for each group belonging to the first division ID.

For instance in the example of FIG. 14, for the number of years of continuous service, the average values and standard deviations of group i, j, k are calculated to be 24.0, 16.0, 8.0 and 0.0, 0.0, 0.0, respectively.

Next in steps S19 and S21, the distance between group pairs i-j, i-k, j-k are calculated for each attribute.

For instance in the example of FIG. 14, for the number of years of continuous service, the distance between group pairs i-j, i-k, j-k are calculated to be 8.0, 16.0, 8.0, respectively.

In step S23, for each attribute, the group pair which has the largest distance between group pair and its maximum value max{G(p,N_{g},n;i,j)} will be determined.

For instance, in the division example of FIG. 14, for the number of years of continuous service, the largest distance between group pairs max{G(p,N_{g},n;i,j)} is determined as 16.0.

In step S25, the largest distance between group pairs max{G(p,N_{g},n;i,j)} for each attribute will be added over a plurality of attributes p, and the sum of the largest distance between group pairs Σₚmax{G(p,N_{g},n;i,j)} will be obtained.

For instance, in the example shown in FIG. 14, the sum of the largest distance between group pairs Σₚmax{G(p,N_{g},n;i,j)} is calculated to be 24.6.

And in steps S27-S31, for each attribute p, of all the division modes (division ID), the division mode or division ID where the largest distance between group pairs max{G(p,N_{g},n;i,j)} is maximized will be determined.

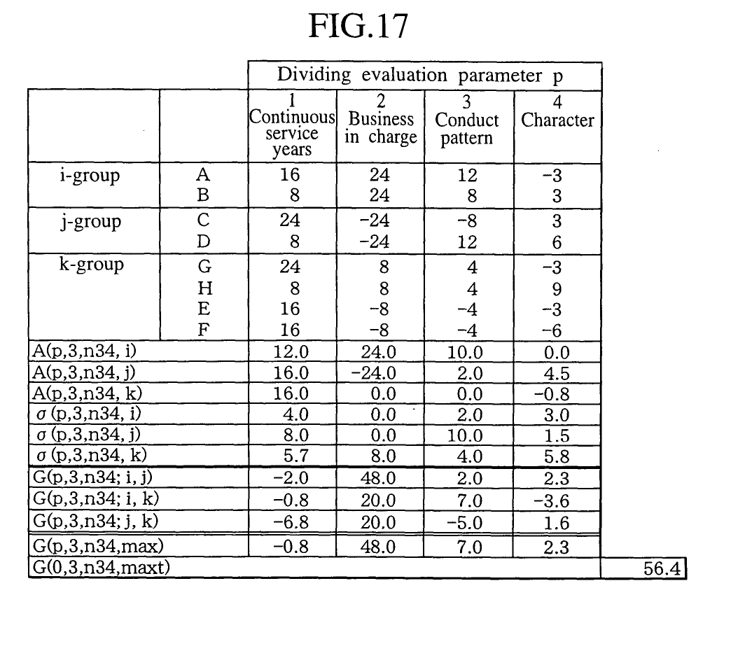

For instance if the division modes of FIG. 14 to FIG. 17 are the entire division mode with division number 3, the largest distance between group pairs for a number of years of continuous service will be 16.0 and the division mode will be determined to be as shown in FIG. 14. Similarly the largest distance between group pairs for business in charge will be 48.0, and the division mode will be determined to be as shown in FIG. 17. The largest distance between group pairs for conduct pattern will be 7.0 and the division mode will be determined to be as shown in FIG. 17. The largest distance between group pairs for character will be 8.1 and the division mode will be determined to be as shown in FIG. 14.

Also, in step S33, among all the division modes (division ID), the division mode or division ID where the largest distance between group pairs max{G(p,N_{g},n;i,j)} is maximized will be determined.

For instance if division modes shown in FIG. 14 to FIG. 17 are the entire division modes with division number 3, the sum of the largest distance between pairs will be 56.4 and the division mode will be determined to be as shown in FIG. 17.

Similarly in the following, for 4 to Nₜ of the division numbers N_{g}, together with determining the division mode for each attribute p where the largest distance between group pairs max{G(p,N_{g},n;i,j)} is maximized, the division mode where the largest distance between group pairs sum Σₚmax{G(p,N_{g},nc,i,j)} is maximized will be determined.

And in step S35, when the division numbers N_{g} coincides with Nₜₘ, the procedure will be proceed to S39. Now, in the division mode, care is taken not to make a plurality of groups where the group element is only one person. This is because if there are a plurality of groups with one person each, when workers with a maximum value and minimum value of the dividing standard parameter are allotted to each group, the difference of dividing evaluation parameters between the groups will become the largest and evaluation for other cases will not be able to be made properly.

By these processes, for each division number N_{g}, the division mode for each attribute p where the largest distance between group pairs max{G(p,N_{g},n;i,j)} will be maximized may be determined and also the division mode where the sum of the largest distance between group pairs Σₚmax{G(p,N_{g},n;i,j)} is maximized may be determined. Also at that time, the division mode where the largest distance between group pairs max{G(p,N_{g},n;i,j)} for each attribute is second in size and also division mode third in size and the like may be determined. Also the division mode where the sum of the largest distance between group pairs Σₚmax{G(p,N_{g},n;i,j)} is second in size and also the division mode where the sum of the largest distance between group pairs is third in size and the like may be determined.

Again with reference to FIG. 7A, in step S05, the division mode where the largest distance between group pairs ₘₐₓ{G(p,N_{g},n;i,j)} or sum of largest distances between group pairs Σₚmax{G(p,N_{g},n;i,j)} obtained above will be maximized will be outputted together with the largest value according to a number (Nₒᵤₜ) of outputs.

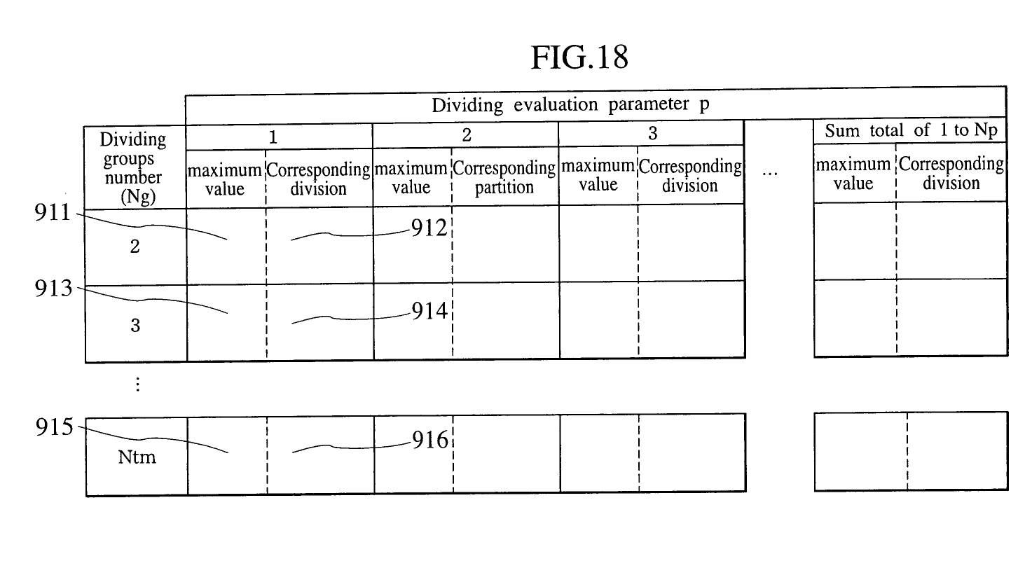

FIG. 18 shows the display screen of the division mode and maximum value where the largest distance between group pairs max{G(p,N_{g},n;i,j)} and sum of largest distances between group pairs Σₚmax{G(p,N_{g},n;i,j)}.

In this figure, for example in 911, among division modes (division ID) with division number 2, the largest value of the largest distance between group pairs max{G(p,N_{g},n;i,j)} for the number of years of continuous service e1 will be displayed, and in 912 the division ID of the division mode which gives the largest distance between group pairs max{G(p,N_{g},n;i,j)} will be displayed.

Also, in 913, among division modes (division ID) with division number 3, the largest value of the largest distance between group pairs max{G(p,N_{g},n;i,j)} for the number of years of continuous service e1 will be displayed, and in 914 the division ID of division mode which gives the largest distance between group pairs max{G(p,N_{g},n;i,j)} will be displayed.

When division modes where the largest distance between group pairs max{G(p,N_{g},n;i,j)} for each attribute is second in size and third in size and the like, or division modes where the sum of largest distances between group pairs Σₚmax{G(p,N_{g},n;i,j)} are second in size and third in size and the like are displayed, they will be displayed in order of size below the division mode where the largest distance between group pairs for each attribute ₘₐₓ{G(p,N_{g},n;i,j)} is maximum or where the sum of distances between group pairs Σₚmax{G(p,N_{g},n;i,j)} is maximum.

In the table shown in FIG. 18, by not displaying contents of boxes which are not selected, or by change the fonts of the contents of selected boxes (large words, bold words and the like), or by coloring the background of selected boxes, selected parts may be made more conspicuous. Also numbers may be assigned to corresponding boxes in order of magnitude of Max{G(p,N_{g},n;i,j)} or sum Σₚmax{G(p,N_{g},n;i,j)}, or the indication color of the background of boxes may be changed.

With reference to FIG. 7A once again, in step S06, Nₒᵤₜ division results which differ largely between groups displayed in this way will be, for instance, read by the chairperson of the meeting, and the division combination (division mode) will be selected.

In step S06, if it is judged that there are no adequate division combinations, the routine goes to step S07 and a judgement will be made whether the number of displays should be increased or not.

Then in the case where the number of displays is increased, procedure will be return to step S05 (S07). On the other hand, when the number of displays is not increased, the procedure will be return to step S02 and the initially set attribute value or its weighted coefficient will be changed.

The process will be executed in this way until a suitable division combination is defined.

If a suitable division mode is displayed in step S05, the division mode will be selected in step S06 and the selected division group mode will be displayed in step S08.

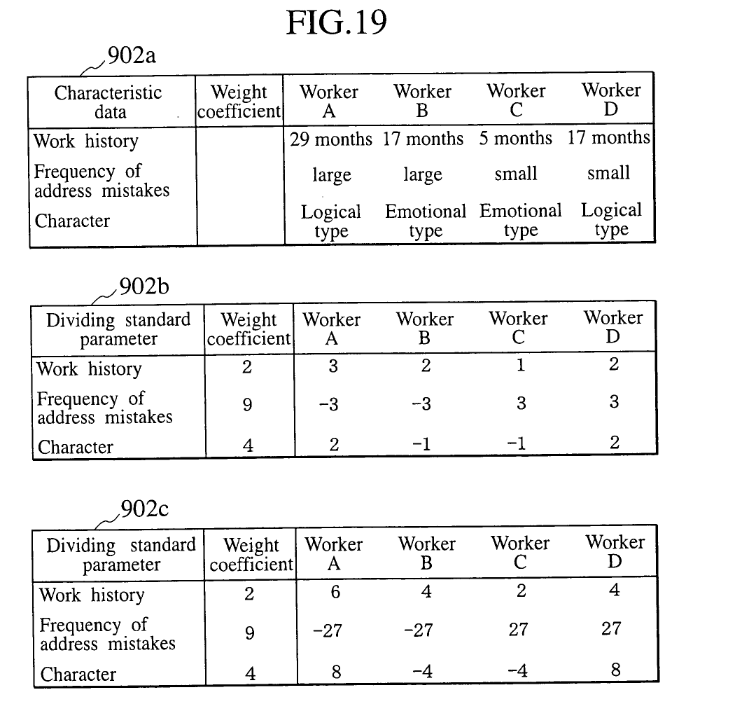

The above will be explained with a simple example. The example shown in FIG. 19-FIG. 22 is an example of the division of four workers. In 902a of FIG. 19, three items, work history, “frequency of errors in address” and character, were extracted from the database. As shown in 902b of the figure, these three are set up as dividing standard parameters and weight coefficients are set up for these items. Also, as shown in 902c of the same figure, values of dividing standard parameters are set for each worker.

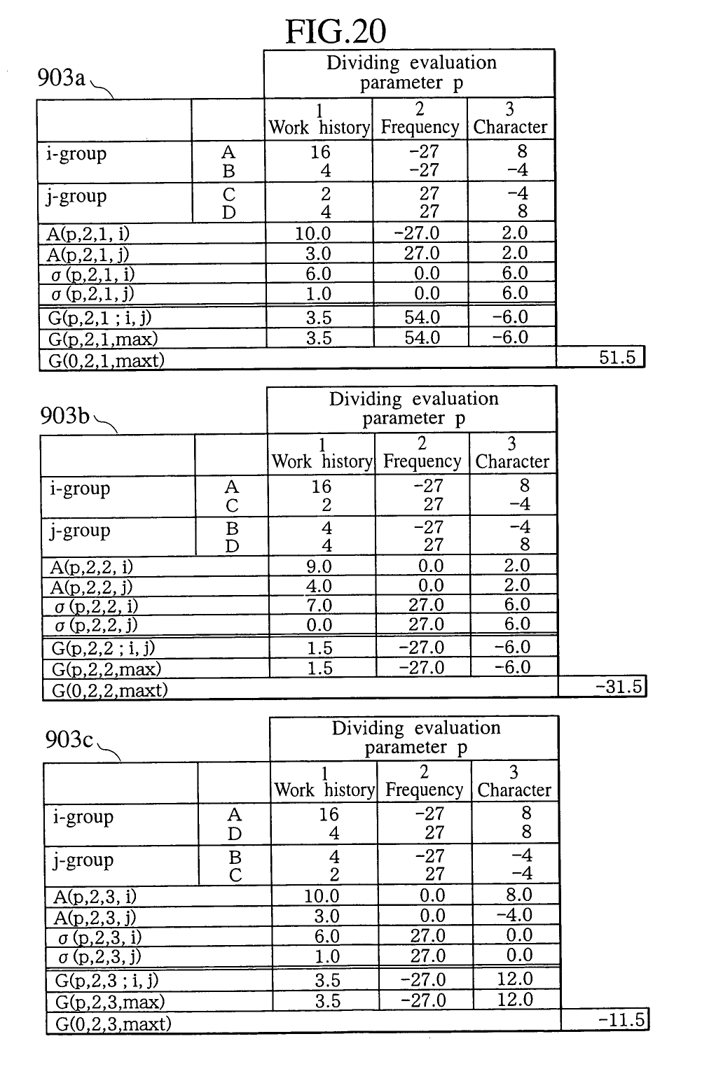

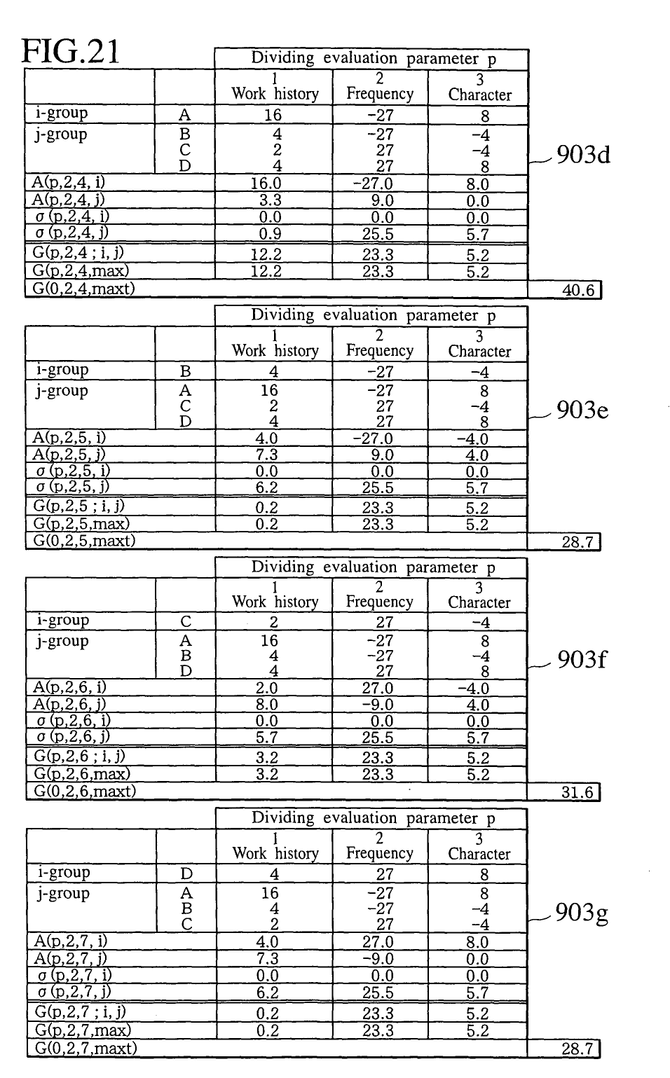

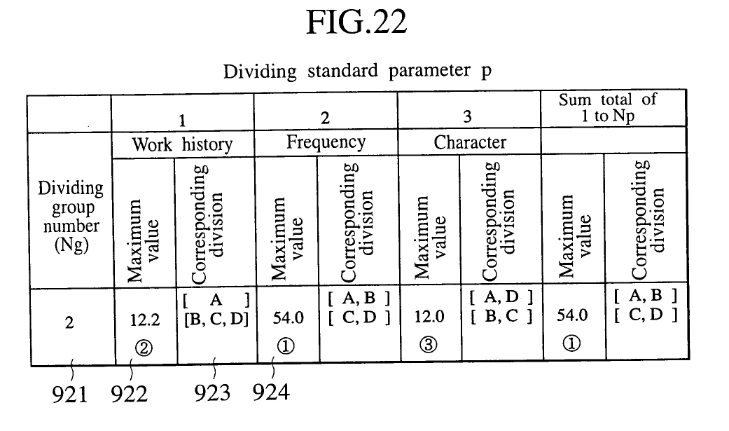

Also, as shown in FIGS. 20-21, the largest distance between the group pairs for each attribute value for each division combination, and the maximum value of the total sum will be obtained and will be indicated together with their division mode as shown in FIG. 22. In this case, as shown in 921 of the same figure, the number of groups is only 2 (if 3, a plurality of groups with only one person will be created). Also, the largest distance between group pairs and the division mode which gives it are shown in 922 and 923 of the same figure. Also the difference between group pairs of the dividing standard parameter is shown in 924 according to size. Now, in this case, “the output number (Nₒᵤₜ) of candidates for division combination” is set as 4. From this figure, it may be seen that it is best for the division for this case to be [A,B] and [C,D] indicated by number \mathring{1}.

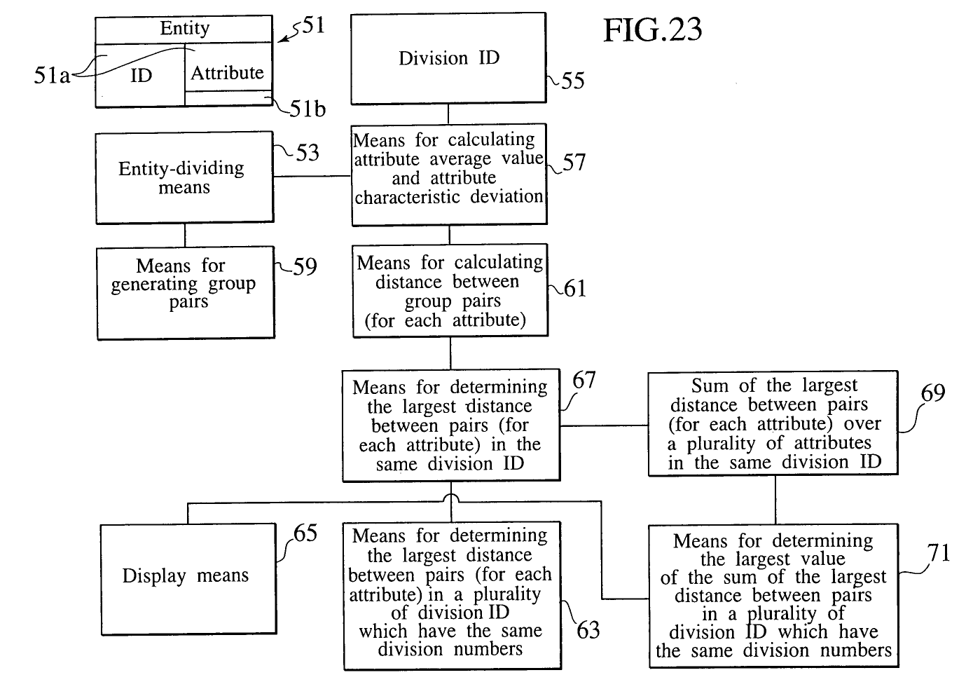

FIG. 23 shows the entity-dividing support apparatus which executes the entity-dividing support method.

As shown in the same figure, this apparatus comprises

a memory 51a which stores IDs and attributes of a plurality of entities,

a memory 51b which stores values of each entity of the attribute,

a means 53 to divide the entities into a plurality of groups in various modes,

a memory 55 which stores a division ID which specifies the division mode,

a means 57 to calculate average values and deviations of attributes of a plurality of entities included in each group of the groups belonging to each division ID,

a means 59 which generates at least one group pair from the groups which belongs to each division ID,

a means 61 which calculates the distance between group pairs for each attribute based on the attribute average values and attribute deviations of groups belonging to the group pairs,

a means 63 which determines a division ID including the group pairs with the largest distance between group pairs, for each of the plurality of division IDs with which the entities are divided into same number of groups, and

a means 65 which generates a display image which displays the division ID which includes the group pairs with largest distance between group pairs and displays its maximum value, for each plurality of division IDs with which the entities are divided into the same number of groups.

Also, the apparatus comprises a memory which stores the weight of each attribute (not illustrated).

Also, the apparatus comprises a means 67 to determine the group pair where the distance between the group pair is largest for each attribute in each division ID when a plurality of attributes are stored for each entity,

a means 69 to calculate the sum of the largest distances between group pairs of each of the attributes over a plurality of attributes, and

a means 71 to determine the division ID where the sum of the largest distance between group pairs is the largest, for each division IDs with which the entities are divided into the same number of groups.

Next as a method to support information processing (intellectual creativity work) of this invention, a method using computer network system, i.e. a method of holding highly efficient conferences on the internet will be explained.

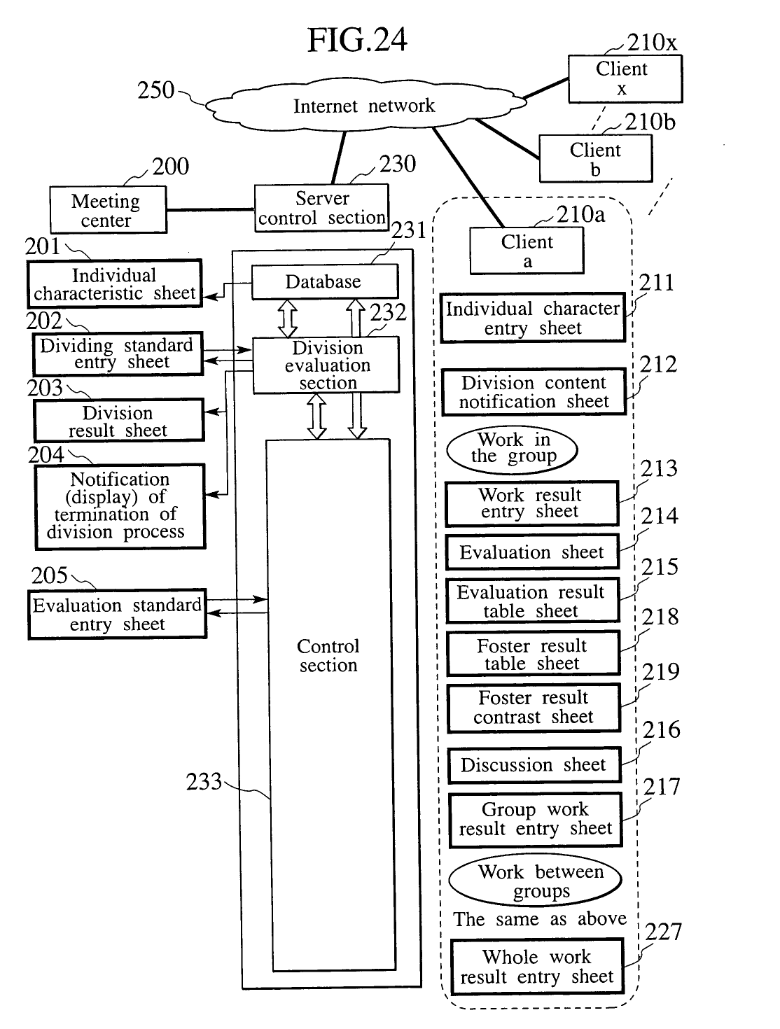

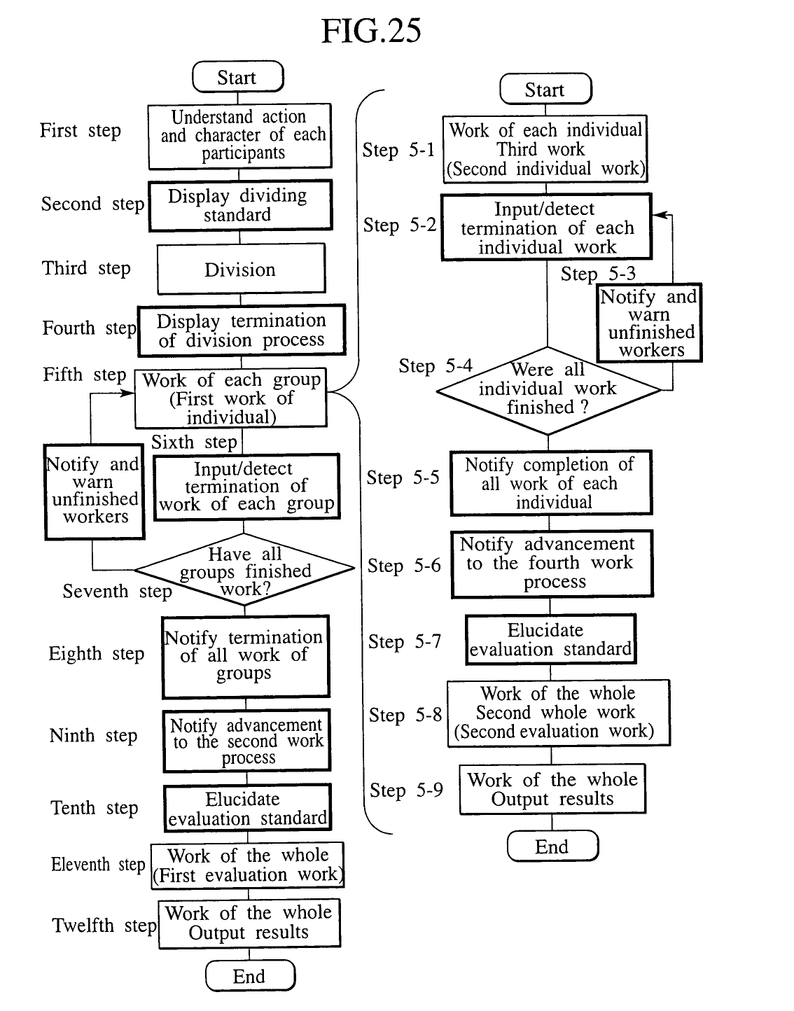

FIG. 24 shows the computer network system which supports a conference by the individual-whole system on the internet. FIG. 25 shows a flow chart of the conference being held by use of the computer network.

As shown in FIG. 24, the computer network system comprises a server control section 230, a meeting center 200 connected to the server control section, which is used by the chairperson (or leader) of the meeting, and a plurality of clients (computers used by participants of the conference) 210a, b . . . x. These are connected via the internet network 250 so that mutual data communication is possible.

The server control section 230 comprises a database 231, division evaluation section 232, a meeting center 200 and a control section 233 which controls information exchange to each client 210a, b . . . x.

The process of the conference using the computer network system comprises generally the following steps.

a step in which a plurality of clients (client computers) are divided by the server into a plurality of groups which include a plurality of clients, respectively, (by the entity-dividing method,)

a step in which information on a request for proposal of a solution to a problem is transmitted to all of the divided clients,

a step in which a first client of each group transmits a solution for the problem to a second client in the group to which the client belongs (based on address information and the like of the second client),

a step in which the server transmits information on a request of for an evaluation of the solution and information on evaluation standards when making the evaluation to all clients,

a step in which the second client sends the first client evaluation information of the solution sent from the first client,

a step in which the server transmits a solution of the first group as a group conclusion to at least one (or all) client belonging to second group,

a step in which the client belonging to the second group discusses the solution from the first group (by meeting on the network and the like)and determines an evaluation of this solution, and

a step in which a representative client belonging to the second group transmits evaluation information of the second group to at least one (or all) client belonging to the first group.

In more detail, it is explained as follows.

As shown in FIG. 25, in the first step, in a meeting center 200, the chairperson understands the action and characteristics of each client. At that time, the worker characteristics data gathered from the database 231 shown in FIG. 24 and information of a worker characteristics entry sheet 211 which each client enters at his own discretion are sent to an individual-whole characteristics sheet 201 of the meeting center 200 via the internet network 250 and the server control section 230.

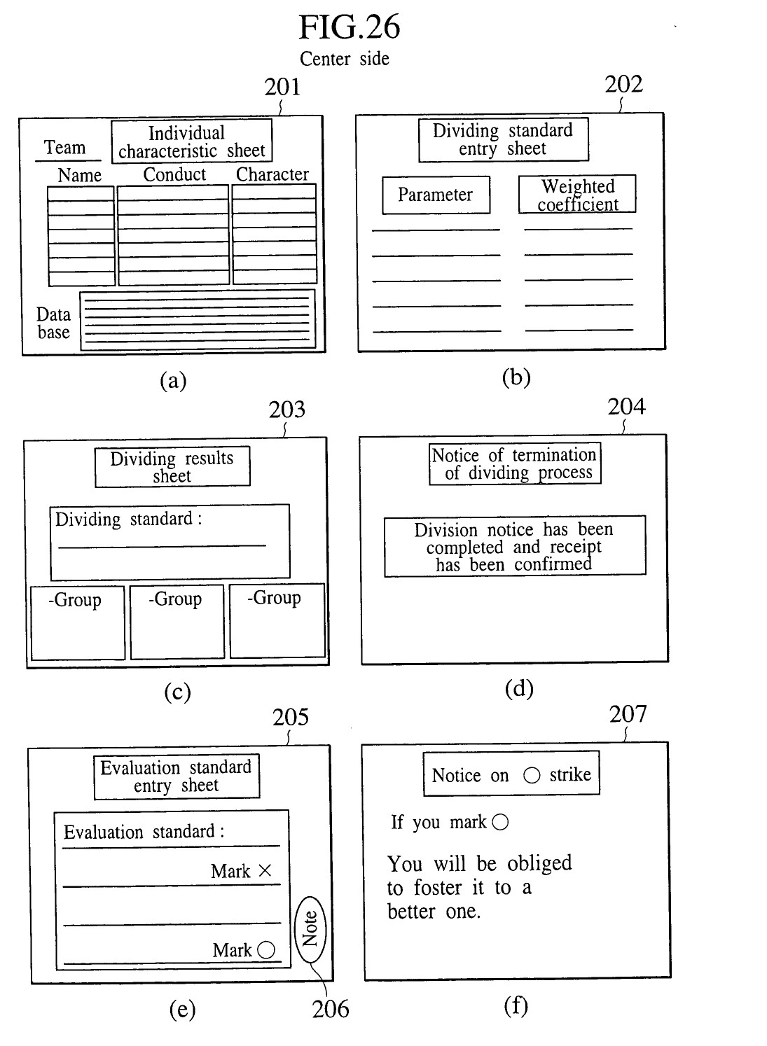

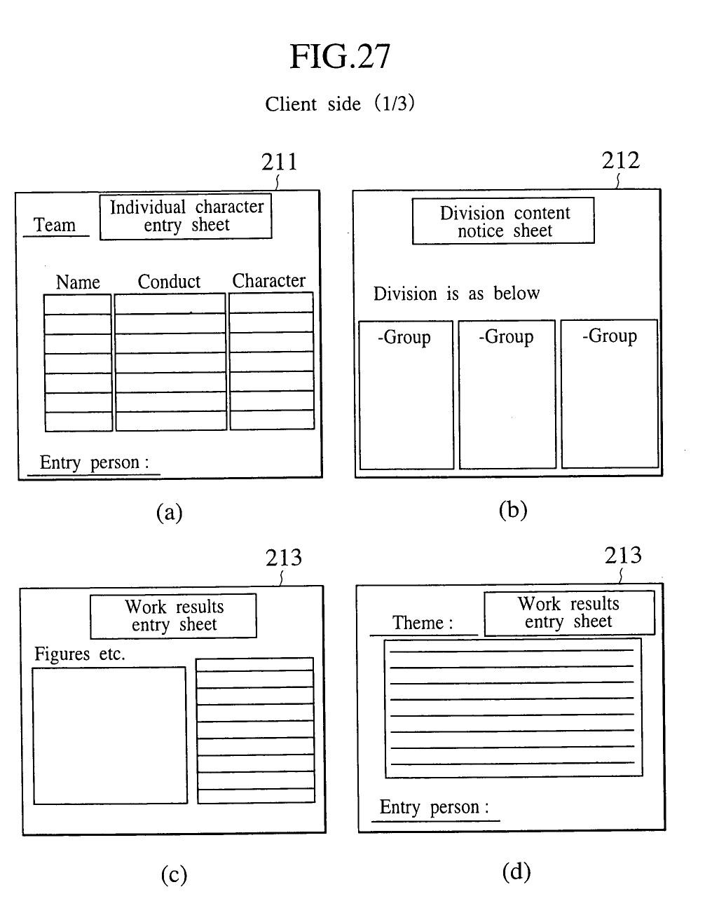

A concrete example of individual characteristics entry sheet (or worker characteristics entry sheet) is shown in FIG. 27(a) and a concrete example of individual characteristics sheet (or worker characteristics sheet) is shown in FIG. 26(a).

Next, in the second step shown in FIG. 25, the dividing standard is displayed. In doing so, the dividing standard entry sheet 202 of FIG. 24 is used. A concrete example of this is shown in FIG. 26(b).

Next, in the third step shown in FIG. 25, actual division will be made. This may be made by use of division software and the like described previously (entity-dividing support method and entity-dividing support apparatus). Based on the results, division contents will be determined. The result will be entered at the meeting center 200. The division result sheet 203 shown in FIG. 24 will be used at that time. A concrete example of this is shown in FIG. 26(c). Also, a division content notification sheet 212 will be used to notify the result to each client. A concrete example of this is shown in FIG. 27(b).

Next, in the fourth step shown in FIG. 25, termination of the division process will be displayed. At that time, notification (display) of termination of the division process 204 of FIG. 24 will be used. A concrete example of this is shown in FIG. 26(d).

Next, at the fifth step shown in FIG. 25, work of each group (or by each group) will be performed. In this step, it is organized so that various data transmissions can be made only within each group and data transmission between groups will be prohibited.

Now in this support method of intellectual creativity work using a computer network system, the theme of the intellectual creativity work (agenda of the congress, request for a proposal of a solution of the set problem) may be notified to each participant by methods such as e-mail at least before beginning the work of each group.

In the work of each group, firstly in step 5-1 shown in FIG. 25, work of each individual will be made and a result (solution) will be entered in a work result entry sheet 213 of FIG. 24.

Concrete examples of the work result entry sheet are shown in (c) and (d) of FIG. 27.

Next in step 5-2, at the meeting center, input of the completion of work of each client and detection of the input will be made and in steps 5-3, 5-4 notice and warning will be made to unfinished clients (workers) and when work of all clients is completed, notice of completion of all the work of each individual will be made (step 5-5).

After this, each client will be notified of advancement to the work process of the fourth work (group work process) (step 5-6).

Then the evaluation standard will be stated clearly (step 5-7). What is used here is the evaluation standard entry sheet 205 shown in FIG. 24 and a concrete example of this is shown in FIG. 26(e). At this time, in order to transmit that “when it is evaluated as better (when ◯ is marked), its knowledge must be cultivated”, a button 206 marked with “note” may be cliked so that the contents may be seen. A concrete example of this note is shown in the notice sheet 207 of FIG. 26(f).

Next, in step 5-8 shown in FIG. 25, the work result of each client will be evaluated by use of the evaluation standard. An evaluation sheet 214 shown in FIG. 24 will be used at this time.

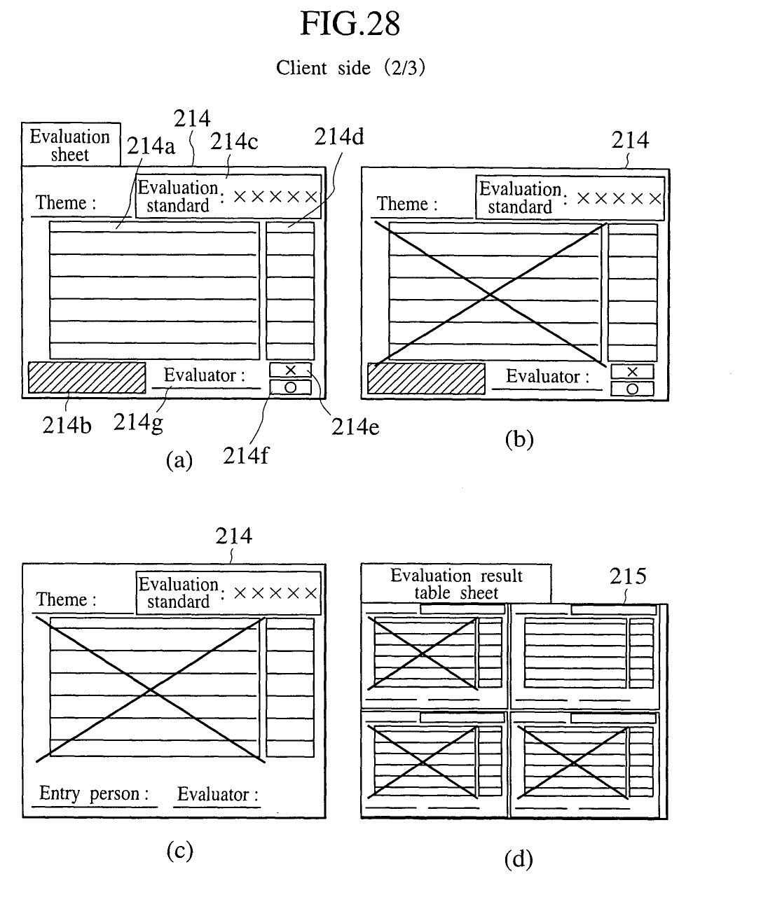

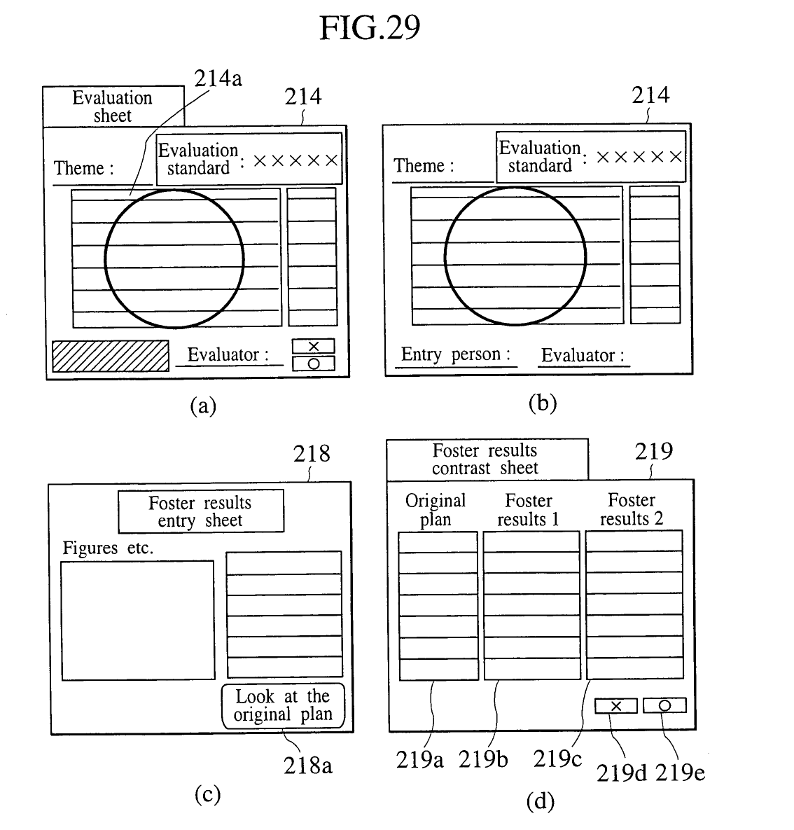

A concrete example of this is shown in FIG. 28(a). As shown in this same figure, the evaluation sheet 214 comprises a work result entry section for each client 214a, a name entry column for entry person (the person who prepared and entered) 214b, a section where the evaluation standard is posted 214c, an evaluator comment column 214d, a click button for an X strike 214e, a click button for an ◯ strike 214f and an evaluator name column 214g. As shown in the same figure, the name entry column for entry person 214b is made so that it may not be seen by the evaluator. When the evaluator pushes the X strike click button 214e or the ◯ strike click button 214f, an X sign or an ◯ sign will be displayed on the screen. FIG. 28(b) shows an example of an X sign. Also examples of ◯ strike are shown in FIGS. 29(a), (b). Here, same as X strike, the name of the entry person may not be seen as shown in FIG. 29(a) during evaluation, and it may be seen as shown in (b) of the same figure after evaluation is completed.

Here, it is preferable that the X sign is indicated ergonomically, for example it is displayed in red and flashes on-and-off, so that the person who sees it may recognize it distinctly. For the ◯ sign, it is preferable to be displayed ergonomically in green, blue or the like so as to provide the impression to be different from the X distinctly. Moreover, an evaluator comment column 214d will be provided so that the reason for striking an X or an ◯ may be entered and the reason for the evaluation results of each evaluator will be described.

After this, the names of persons who made the entry will be disclosed as shown in FIG. 28(c).

Moreover an evaluation results inspection sheet 215 of FIG. 24 will be provided so that the evaluation sheet of each client may be inspected. A concrete example of this is shown in FIG. 28(d). This example shows a case where for four cases of individual work results, one person was impossible to evaluate (could not mark a X sign or ◯ sign) and the other three persons displayed X. For this case of a result being impossible to evaluate, it is preferable for the person who outputted the work result and the evaluator to exchange information (questions and answers and the like) individually and display a X or ◯ mark at the end.

For items evaluated X, discussions will be made on the result between the entry person and the evaluator by use of electronic information instruments. The tools used at this time will be a discussion sheet 216 in FIG. 24. Here e-mail and the like may be used as the electronic information instrument. In this case, it is preferable for the entry person and the evaluator to transmit information only between themselves and hold discussions. However, copies of the results and discussions may be transmitted to other workers in the group and the chairperson.

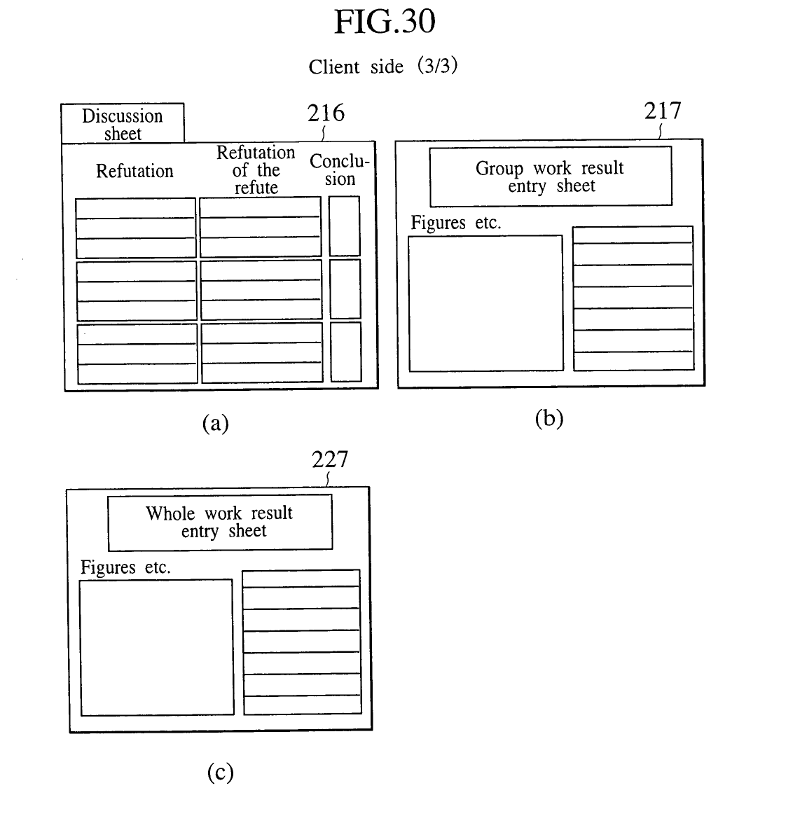

A concrete example of this is shown in FIG. 30(a).

On the other hand, for those evaluated ◯, the evaluator (called client B here) and the entry person (called client A) will foster the knowledge of the contents independently. This result will be entered in a foster result entry sheet 218 shown in FIG. 24. A concrete example of this is shown in FIG. 29(c). As shown in this figure, the foster result entry sheet has a “see the original plan” click button 218a to refer to the original work result struck with an ◯ in the work result entry sheet 213 shown in FIG. 27(c).

After entering the foster results in the foster result entry sheet, as above, evaluation will be executed with the evaluation sheet 214 shown in FIG. 28 by using a suitable evaluation standard, and this will be repeated appropriately (the chairperson may terminate this repetition at a suitable time by perusal of the process, or the termination time may be set previously or the number of times of repetition may set previously).

And, similar to the case of an X strike, the result will be discussed between clients A and B by use of electronic information devices by using the discussion sheet 216 of which a concrete example is shown in FIG. 30(a). E-mail and the like may be used as the electronic information device. In this case, discussion by transmission of data should preferably be made only between the entry person and the evaluator. However, the copies of the results and discussions and the like may be transmitted to other workers in the group and chairperson.

Also a foster result contrast sheet 219 shown in FIG. 24 may be used for each clients A, B to see the results of knowledge foster and the original plan at a glance. A concrete example of this is shown in FIG. 29(d). As shown in the figure, the same content as entered in the work result entry section 214a of the evaluation sheet 214 is posted in the original plan column 219a, and the contents of foster result entry sheet of client A is posted in foster results 1 column 219b, and contents of the foster result entry sheet of client B is posted in foster results 2 column 219c. And as shown in the figure, X ◯ strike button 219d and X strike button 219e may be provided on the foster result contrast sheet so that evaluation may be made.

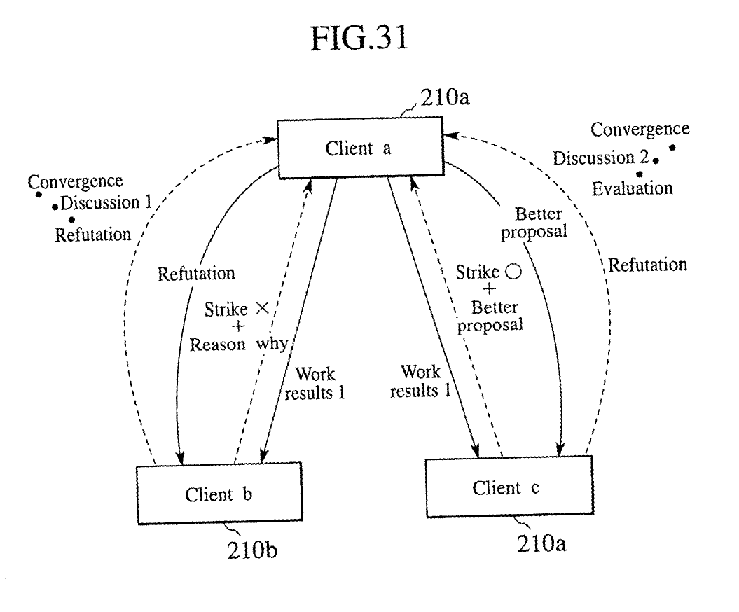

The evaluation and discussion process described above will be typically shown, for simplicity the case of three clients, in FIG. 31. As shown in the figure, work result 1 will be sent from client a (210a) to clients b, c. For example client b (210b) may strike an X and enter the reason for it and the result in the evaluation sheet 214 and send it to client a. To this, client a may refute it by use of the discussion sheet 216 and client b may refute against this, and by repetition of this, discussion will settle down to some content.

On the other hand, assume that client c struck ◯ for the work result 1. This result will be transmitted to client a by the evaluation sheet 214. And client c will prepare a “better proposal” (foster knowledge) and will enter it in the foster result entry sheet 218 and will send it to client a. On the other hand, client A will also prepare a “better proposal” and will enter it in the foster result entry sheet 218 and send it to client c. In order to see the foster results of the two persons at a glance, a foster results contrast sheet 219 is used. These will be evaluated by use of the evaluation sheet 214 and the results will be discussed.

At this time, needless to say, the “better proposal” of client C may be entered in the comment column of evaluation sheet 214 and sent to client a with the first evaluation result.

This discussion through evaluation and objection converges on some content. These evaluation and objection may be realized by, for instance, e-mail or a well known internet software (for instance “net meeting” of Microsoft Co. and the like).

As in the above, work results of clients b, c will be evaluated and discussed.

Through these evaluations and discussions, the result of the group will be derived. The work results of the whole group will be outputted as shown in steps 5-9 of FIG. 25. At this time, a group work result entry sheet 217 will be used.

A concrete example is shown in FIG. 30(b). This output may be made by the representative (may be chosen arbitrarily) of the group. Also a method may be used whereby the output is made to the conference chairperson through the server and then sent from the chairperson to members of a different group by the chairperson, or needless to say, in parallel with sending the message to the chairperson, the output may be sent to a representative or a member of the other group.

All the work of the group will be completed in this way (step 6, step 7 of FIG. 25) and termination of all group work will be notified from the meeting center (step 8 of FIG. 25).

In step 9, notification will be made that the group will advance to the entire work (the second work process) in which the groups get together.

In step 10, the evaluation standard will be elucidated. In doing so, the evaluation standard entry sheet 205 of FIG. 24 may be used.

Thereupon, in step 11 shown in FIG. 25, evaluation of work results will be made mutually between groups. In doing so, the evaluation sheet 214 may be used, more concretely, the contents of group work results entry sheet 217 transferred to it will be used.

Concretely, the evaluation of work results will be made by the following method. Firstly, an individual will make an X strike or an ◯ strike (specify the reason in the case of an X strike, foster knowledge of the work result in the case of ◯ strike) of the evaluation standard for the work knowledge results of the other group. The result will be perused by members of the group and will be discussed by internet conferencing and the like and the evaluation result as the group will be defined. To the work result of other groups, the evaluation result of the group (in case of an X strike, to the effect and reason, for the case of ◯ strike, to the effect and results of fostering knowledge notified at the same time or later on) will be exchanged between groups.

After this, by internet conferencing of all members and the like, the evaluation results will be discussed (by use of discussion sheet 216) and as a result the whole will be integrated.

In step 12 shown in FIG. 25, the work results of the whole will be outputted. At that time, a whole work result entry sheet 227 shown in FIG. 24 will be used. A concrete example of this is shown in FIG. 30(c).

By the above structure, the method of information processing of the present invention may be conducted effectively via the internet by means of freely using of electronic information devices of IT (information technology).

Also, the method information processing of this invention may be adapted to a case where the means of information processing is an organized group consisting of a plurality of computer agents.

For instance consider the case of a money market simulated by a plurality of computer agents. For instance, let us prepare eight computer agents which comprises money market data, field observation, analysis of information management process of market participants and recognition mechanism, and comprises a genetic algorithm.

To these agents 1-8, various financial market data common to all will be inputted and, for example, by perceiving inspection of the job site, analysis of a process of information processing by market participants, data (knowledge) of recognition mechanism, knowledge expression, knowledge evaluation data, knowledge evaluation function and study algorithm which are obtained from results of interviews with eight financial dealers (actual people), or program of each agent on manipulation of screening, intersection, mutation or difference in contents of simulation experienced in the past, weighted coefficients will be defined and, by use of the evaluation division software, the agents will be divided so that differences between them are enlarged.

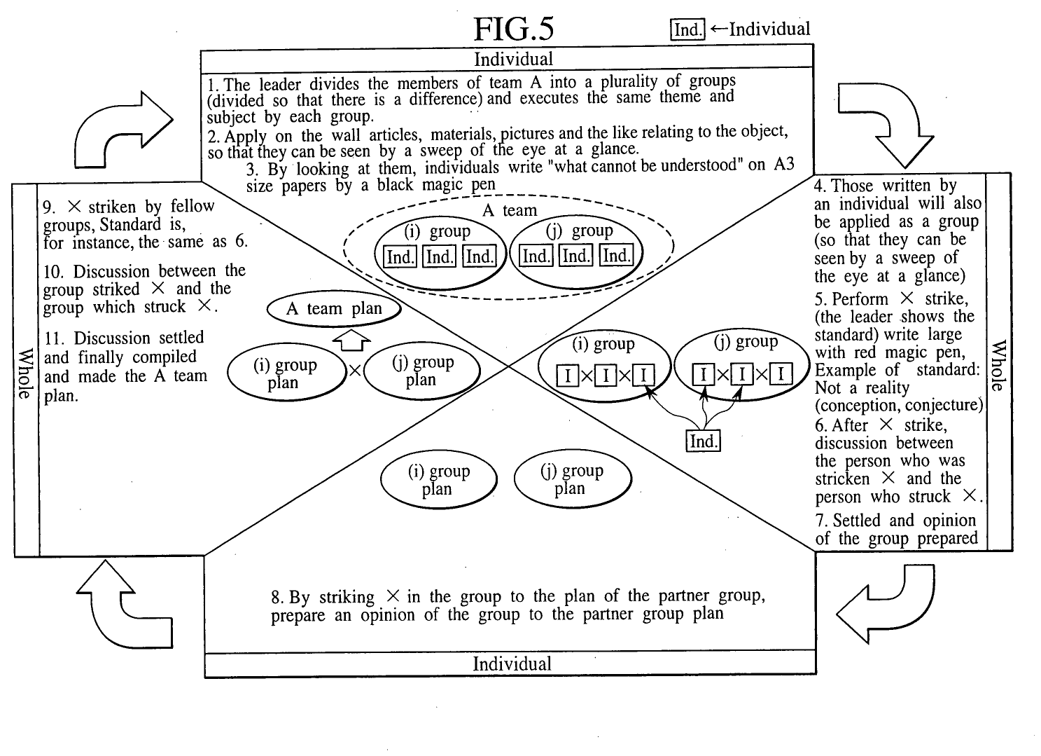

For example, these will be divided into A group (agents 1-4) and B group (agents 5-8). Each agent comprises a production memory which stores knowledge and the like and a working memory which is coupled to the production memory by a recognition cycle and stores hypothesis and results of experiments. Agents 1-4 will commonly have a common working memory which may be freely outputted, perused and used. This is shown in FIG. 6. Agents 5-8 will also have a similar composition.

First, for work inside group A, a simulation over some period will be made for each agent 1-4.

Each result of simulation will be inputted to another agent in group A and each agent will make an evaluation of the predicted results of the three other agents on the basis of the unified evaluation standard “the difference between my simulation result is larger than a level”. Next, the evaluation result will be exchanged between agents 1-4 and in order of agents 1 and 2, agents 1-3 and similarly in the following, knowledge and the like largely related to the items which differ in the results between agents will be mutually perused and revised by the agents.

The most simple concrete example of the method of this revision of knowledge is, for instance, to let the item data of information processing means A be DA and the item data of information processing means B be DB and by use of coefficient C set appropriately, let the new data of information processing means A be DA*C+DB*(1−C) and, on the other hand, let the new data of information processing means B be DA*(1−C)+DB*C. This coefficient C may be set appropriately according to the item of the data and, also, may be fixed by a genetic algorithm.

By use of knowledge modified in this way, simulation may be repeated individually by each agent. This will be repeated until the dispersion of simulation results of each agent is smaller than a level. The result obtained in this way will be the A group result.

Similarly, as the work in the B group, the work of the individual, evaluation, modification of knowledge and the like will be repeated for each agent 5-8 and the result where the dispersion of simulation results of each agent is smaller than a level will be made the simulation result of group B.

Next, the simulation results of A group and B group will be exchanged between the groups and evaluation of each other will be made. For the evaluation standard, for example “the difference in simulation results between our group is larger than a level” will be used. By this, the knowledge and the like related largely to the areas where the difference is large will be modified between A group and B group by a predetermined method. By the modified knowledge and the like, each group will for the second time repeat simulation, evaluation and modification of knowledge and the like in the individual→group process and will derive results of each group. By the process of repetition of making evaluation between groups, discussions will be made by computer agents and will be repeated until the difference of simulation results between groups becomes smaller than a level and simulation result of the whole will be derived.

By this method, compared to the conventional information processing method using a simple genetic algorithm, very high precision results may be obtained in a short time. Besides the application to a simulation of a financial market, this method may be applied to, for example, the effective operational methods of production installations, the effective arrangement methods of electronic circuits on substrates, highly efficient derivation methods of designs and compositions, to robots with learning functions, elucidation of genome and development of application techniques and the like. Further, needless to say, it is very effective in information management software in knowledge management, and intention decision software, production optimization software and new technology development software and the like in enterprises and public institutions, and also software related to discoveries in natural science or inventions.

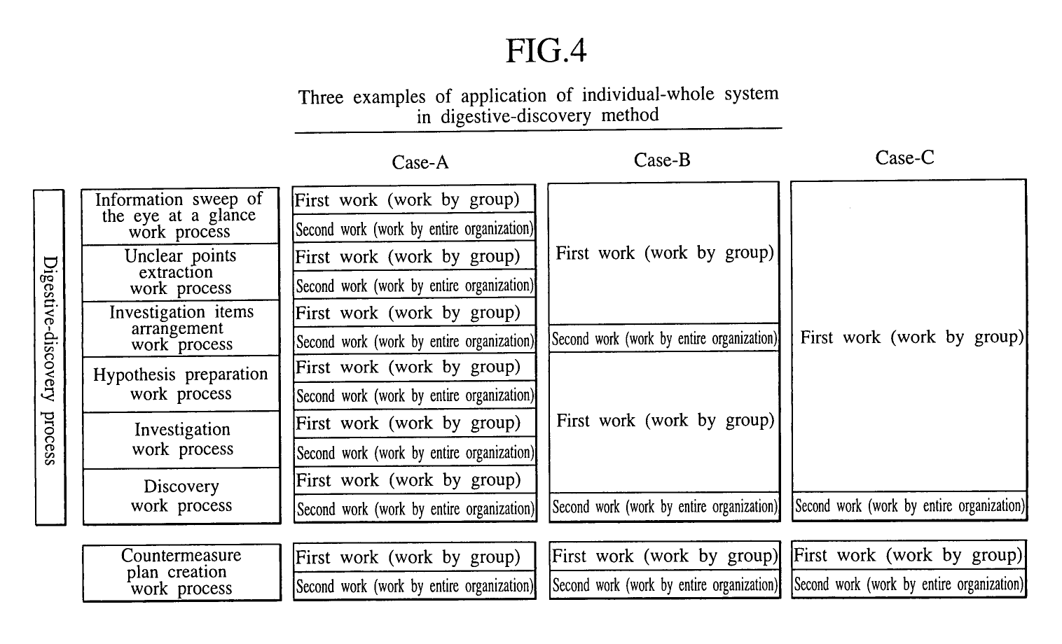

The work of the individual-whole system performed by a combination of the “individual” work and the “whole” work as described above or by repetition of these works is shown typically in FIG. 5 (in this example only the case of “X strike” evaluation is shown). In the present invention, as information processing is performed by the “individual” and “whole” systems, the variety of viewpoints and ways of thinking which each individual and each group possess will be assured.

Up to now, as a method for information processing, discussions by debates is known. In this method, division is made into a plurality of groups which differ in opinions or conclusions of the theme of the discussion and will mutually criticize the opinions and conclusions of other groups and will argue to support their own opinions and conclusions. It may be that the entity of this method is “competing for victory or defeat” in a dispute with other groups.

However this conventional “debate method” and the method of this invention is essentially different in two points which will be explained below.

First of all, in the case of the “debate method”, division into groups is made in the stage before information processing is conducted so that differences will appear. In other words, in the case of the present invention, division is made so that there will be differences in the information processing results whereas in the conventional debate method, group division is made according to opinions or conclusions presented at the first stage of the discussion where investigation of the object is still insufficient. Therefore when they have to change or modify their own opinion due to investigation results made later on, opinions of other groups, and related information and knowledge, they will not be able to cope with and as a result, information processing results borne by new intellectually stimulating other groups by changed or modified opinion cannot be expected. Therefore, not to mention the group, the entire organization will not be able to perform deep information processing.

Secondly, the debate method does not have as an entity a process of evaluating the results of other groups by the same judgement standard. Therefore the discussion will be based on each other's subjectivity and will eventually turn into a futile discussion.

Due to the two points explained above, the debate method is essentially different from the method of this invention. That the conventional debate is insufficient as an information processing method is a fact well known from open debates on television and the like which only end in futile discussions and cannot realize the deep processing of information.

As explained in detail, by the embodiment of the information processing method of this invention, emergence of intelligent creativity may actually be obtained by an organized group organized by a plurality of information processing means consisting of a plurality of computers or computer agents each having knowledge and the like.

Also, in an organized group composed of people, by good use of intellectual creativity of each individual which compose the group, intelligent creativity level results which could not have been obtained by an individual but only as a group have been achieved for efficient information processing in a short time at low cost and also by use of the support system and tools of the invention, the work may be achieved efficiently in a short time at low cost.

1. An entity-dividing method which comprises,
(a) a step for inputting IDs and attributes of a plurality of entities into a computer,
(b) a step for inputting to the computer or calculating by the computer the value of said attributes of each entity,
(c1) a step in which the computer divides the entities into a plurality of groups by a plurality of modes or methods,
(c2) a step in which the computer gives a division ID to each of said modes or methods of division,
(d) a step in which the computer calculates an average value and deviation of attributes of the entities belonging to each group of the groups belonging to each division ID,
(e) a step in which the computer generates at least one group pair from said groups belonging to each division ID,
(f) a step in which the computer calculates a distance between the group pair based on the attribute average value and attribute deviation of groups belonging to said group pair,
(g) after the repetition of the steps (c)-(f) for a plurality of division IDs with which said entities are divided into the same number of groups, a step to determine a group division ID which includes the group pair where the distance between group pair is maximum, for each division IDs with which said entities are divided into the same number of groups, and
(h) for each division IDs with which said entities are divided into the same number of groups, a step to display on a display device the division ID which includes the group pair where the distance between the group pair is maximum together with the maximum value.

2. The method according to claim 1, which includes a step for inputting a weight of each attribute.

3. The method according to claim 1, wherein in the step (a) a plurality of attributes are entered, and in the step (b) the values of the attributes are entered or calculated, and the steps (d), (f), (g) and (h) include processing of each attribute.

4. The method according to claim 3, which comprises (i) a step in which the computer determines, in each division ID, for each attribute, the group pair where said distance between the group pair becomes the largest,
(j) a step in which the computer calculates the sum of the largest distance between the group pair of each attribute, and
a step in which the computer, after repeating said steps (c)-(f), (i), (j) for division IDs with which said entities are divided into the same number of groups, determines for each division IDs, the division ID where the sum of the largest distance between group pairs is largest.

5. The method according to claim 3, which comprises (k) a step in which the computer calculates the sum of the distance between group pairs for each the attribute in each division ID, and
a step in which the computer, after repeating said steps (c)-(f), (k) for division IDs with which said entities are divided into the same number of groups, determines for each division IDs, the division ID where the sum of the distance between group pairs is maximized.

6. A method to support intellectual creativity work by a computer network system provided with at least one server and a plurality of clients, which comprises
a step in which the server divides said clients into a plurality of groups including a plurality of clients,
a step for transmitting information on a request for proposal of solutions to a problem to all said divided clients,
a step in which a first client of each group sends a solution of said problem to a second client in the group to which the client belongs (based on address information of the second client),
a step in which the server transmits information requesting an evaluation of the solution and an evaluation standard information in making the evaluation to all clients,
a step in which the second client sends the first client evaluation information to the solution from the first client,
a step in which the server sends a solution provided by the first group as a group conclusion to all clients belonging to the second group,
a step in which the clients belonging to the second group discuss the solution from the first group by an internet conference and the like and determine an evaluation of the solution, and
a step in which a representative client belonging to the second group transmits evaluation information of the second group to all clients belonging to the first group.

7. The method according to claim 6, wherein the request information requesting the solution includes address information of other clients of the group to which each client belongs and does not include address information of clients of other groups to which each client does not belong.

8. The method according to claim 6, which comprises
a step in which the server transmits to all clients information requesting evaluation including an improved proposal of the solution in case where the solution is evaluated as “good”, and
a step in which the server transmits to all clients information requesting evaluation including a reason why in case the solution is evaluated as “bad”, wherein
said evaluation information includes an improved proposal in a case where the evaluation is “good” and includes a reason why in a case where the evaluation is “bad”.

9. The method according to claim 6, which includes
a step in which the first client transmits an improved solution to the second client in a case where the evaluation by the second client is “good”.

10. The method according to claim 9, which comprises a step in which the server receives solutions as a client conclusion from each client belonging to each group, and prepares a table to display said each conclusion to at least one client belonging to said each group, and transmits said table to at least one client belonging to said each group,
a step in which each client adds an opinion to the client conclusion set fourth in the table and sends it to at least one other client in the group, and
a step in which each client discusses said client conclusion by an internet conference and the like and determines the group conclusion of said group.

11. The method according to claim 6, which includes a step in which, in a case where the evaluation from the second group is “good”, at least one client of the first group prepares an improved solution by an internet conference and the like and a representative client of the first group will send the improved solution to a client belonging to the second group.

12. The method according to claim 10, which comprises a step in which the clients belonging to the second group determine the representative client by an internet conference and the like.

13. A method of information processing which is performed by organized groups comprising a plurality of independent information processing means, the means individually having knowledge, knowledge expression, knowledge evaluation data, knowledge evaluation function, concepts, and algorithms of learning and the like (called knowledge and the like in the following), the method comprising
a division process where said information processing means are divided into a plurality of groups,
followed by a first work process conducted in a group to derive the results of information processing as the group, and
followed by a second work process conducted by the whole to derive the results of information processing as a whole organized group by integrating results of the information processing by said group, wherein
the division process being to divide into groups so that difference in the results of information processing appears between groups,
the first work process is for each group to advance work independently of other groups,
the second work process is characterized by comprising a first evaluation work process where mutual evaluation of results of information processing of other groups is made by use of a common evaluation standard.

14. The method of information processing of claim 13, wherein the second work process is characterized by comprising,
a work process 2-1 in which information processing result of the group is exchanged,
a work process 2-2 (first evaluation work process) in information processing results of other groups are evaluated in each group independently by use of the same evaluation standard (the first evaluation work process),
a work process 2-3 in which the results of the evaluation are displayed, outputted, and informed to other groups,
a process 2-4 in which among knowledge and the like possessed by each group, the knowledge related to said evaluation result are exchanged between groups,
a process 2-5 in which knowledge possessed by the group is revised based on the knowledge possessed by other group obtained by exchange of knowledge, and
a work process 2-6 in which information processing results as a whole where difference in the information processing results between each group is within a range is obtained.

15. The method of information processing of claim 13, wherein the second work is characterized by comprising,
2-1 work process in which information processing results as the group are exchanged,
a 2-2 work process (first evaluation work process) in which information processing results of other groups are evaluated independently by each group by use of the same evaluation standard,
a 2-3 work process in which said evaluation results are displayed, outputted and informed to other groups,
a 2-7 work process in which the information processing results executed by other groups are intellectually fostered,
a 2-8 work process in which the information processing result is fostered by the group which originally derived the information result which are intellectually fostered by others, be executed in parallel and independently of the 2-7 work process,
a 2-9 work process in which results of the 2-7 work process and results of the 2-8 work process are exchanged,
a 2-10 work process in which results of the 2-7 work process and results of the 2-8 work process are evaluated by the same evaluation standard,
a 2-11 work process in which the evaluation result of the 2-9 work process are displayed, outputted and notified to other groups,
a 2-12 work process in which among knowledge and the like possessed by each group, the knowledge related to said evaluation result are exchanged between groups, and the knowledge possessed by the group is modified based on knowledge possessed by other groups obtained by exchange, and
a 2-13 work process to obtain information processing results of the whole where difference in information processing results between each group are within a range.

16. A method to support intellectual creativity work by a client in the computer network system, which comprises
a step to receive information from a server on division of a plurality of clients into a plurality of groups,
a step to receive a problem from the server,
a step to receive information on request from the server to propose a solution to a problem,
a step to transmit the solution of said problem to only the clients in a group to which the person belongs,
a step to receive from said server information requesting the evaluation of said solution and evaluation standard information when making said evaluation,
a step to receive from other clients in said group, evaluation information on ones own solution, and
a step in which from clients belonging to other group or from the server, the evaluation information of the other group is transmitted.

17. The method of claim 16, which includes a step to receive information requesting the inclusion of an improved proposal to said solution in the evaluation when the server evaluates the solution as “good”, and
a step to receive information requesting inclusion of reason in said evaluation when the server evaluates the solution as “bad”.

18. The method of claim 16, which includes a step to transmit an improved solution to two other clients when an evaluation of “good” is received from an other client.
